(19) United States
(12) Patent Application Publication
(10) Pub. No.: US 2005/0120011 A1
(43) Pub. Date: Jun. 2, 2005

(54) Code, method, and system for manipulating texts

(75) Inventors: Peter J. Dehlinger, Palo Alto, CA (US); Shao Chin, Felton, CA (US)

Correspondence Address: PERKINS COIE LLP, P.O. BOX 2168, MENLO PARK, CA, 94026, US

(73) Assignee: Word Data Corp.

(21) Appl. No.: 10/993,462

(22) Filed: Nov. 18, 2004

Related U.S. Application Data
(60) Provisional application No. 60/525,442, filed on Nov. 26, 2003.

(51) Int. Cl. G06F 7/00

(52) U.S. Cl. 707/3

(57) ABSTRACT

Disclosed are a computer-readable code, system and method for combining texts to form novel combinations of texts related to a desired target concept, where the concept is represented in the form of a natural-language text or a list of descriptive word and/or word-group terms. The system operates to find primary and secondary groups of texts having highest term match scores with a first and second subset of terms in the concept, respectively. It then generates pairs of texts containing a text from each of the primary and secondary groups of database texts, and selects for presentation to the user, those pairs of texts having highest overlap scores as determined from one or more of (i) term overlap, (ii) term coverage, (iii) feature-specific cross-correlation, (iv) attribute-specific correlation, and (v) citation score of one or both texts in the pair.

This application claims priority to U.S. Provisional Patent Application Ser. No. 60/525,442, filed on Nov. 26, 2003, which is incorporated herein in its entirety by reference.

### FIELD OF THE INVENTION

The present invention relates to a computer system, machine-readable code, and an automated method for manipulating texts, and in particular, for finding and combining texts that represent a new concept or idea of interest.

### BACKGROUND OF THE INVENTION

There are a variety of models that have attempted to explain the nature of the creative process involved in generating novel concepts and ideas. One relatively simple model, and the one generally employed for evaluating inventive concepts, is to treat to a concept-in this case, an invention-as a modification of one or more identifiable prior-art references. In this model, all published technical references are treated as building blocks from which an inventor can construct new concepts, either by modifying a single reference in a novel way, or by combining elements from two or more references to produce a novel concept.

In theory, there are an almost limitless number of new combinations of elements that one might combine from existing texts to produce new concepts. This is true whether the concept is an invention, a purely scientific or technical concept, or a literary concept, such as a novel storyline. Of these many possible combinations, only a relatively few will have merit, meaning that they are perceived as valuable scientific, technical, or literary contributions by others, or have unexpected or unsuggested advantages, or solve a problem or achieve commercial success.

Heretofore, a variety of computer-assist approaches have been proposed to aid human users in generating and/or evaluating new concepts. Computer-aided design (CAD) programs are available that assist engineers in the design phase of engineering or architectural projects. Programs capable of navigating complex tree structures, such as chemical reaction schemes, use forward and backward chaining strategies to generate complex novel multi-step concepts, such as a series of reactions in a complex chemical synthesis. Computer modeling represents yet another approach to applying the computational power of computers to concept generation. This approach has been used successfully in generating and “evaluating” new drug molecules, using a large database of known compounds and reactions to generate and evaluate new drug candidates.

Despite these impressive approaches, computer-aided concept generation has been limited by the lack of easy and reliable methods for extracting and representing text-based concepts, that is, concepts that are most naturally expressed in natural-language texts, rather than a graphical or mathematical format that is more amenable to computer manipulation.

There is thus a need to provide computer-assist tool that can be used in generating novel concepts using text-based elements and objects as the building blocks for novel concepts.

### SUMMARY OF THE INVENTION

In one aspect, the invention includes a computer-assisted method for combining texts to form novel combinations of texts related to a desired target concept that is represented in the form of a natural-language text or a list of descriptive terms that include words and, optionally, word groups. If the target concept is represented in the form of a natural-language text, the method operates first to extract descriptive word and, optionally, word-group terms from the text, to form a list of descriptive terms. A database of target-related texts is searched to identify a primary group of texts having highest term match scores with a first subset of the concept-related descriptive terms, and then searched again to identify a secondary group of texts having the highest term match scores with a second subset of the concept-related descriptive terms, where the first and second subsets are at least partially complementary with respect to the terms in the list.

From these searches, the method generates pairs of texts containing a text from the primary group of texts and a different text from the secondary group of texts, and selects for presentation to the user, those pairs of texts that have highest overlap scores as determined from one or more of:
(1) overlap between descriptive terms in one text in the pair with descriptive terms in the other text in the pair;
(2) overlap between descriptive terms present in both texts in the pair and said list of descriptive terms;
(3) for one or more terms in one of the pairs of texts identified as feature terms, the presence in the other pair of texts of one or more feature-specific terms defined as having a substantially higher rate of occurrence in a feature library composed in texts containing that feature term;
(4) for one or more attributes associated with the target invention, the presence in at least one text in the pair of attribute-specific terms defined as having a substantially higher rate of occurrence in an attribute library composed in texts containing a word-and/or word-group term that is descriptive of that attribute; and
(5) a citation score related to the extent to which one or both texts in the pair are cited by later texts.

The descriptive terms in the target concept may be identified as non-generic terms that have a selectivity value, calculated as the frequency of occurrence of that term in a library of texts in one field, relative to the frequency of occurrence of the same term in one or more other libraries of texts in one or more other fields, respectively, above a given threshold value.

In particular, where the target concept is represented in the form of a natural-language text, the step of forming a list of descriptive target terms may include (1) for each of a plurality of terms selected from one of (i) non-generic words in the text, (ii) proximately arranged word groups in the document, and (iii) a combination of (i) and (ii), determining a selectivity value calculated as the frequency of occurrence of that term in a library of texts in one field, relative to the frequency of occurrence of the same term in one or more other libraries of texts in one or more other fields, respectively, and (2) selecting as descriptive terms, those terms that have a selectivity value above a selected threshold.

The first search may be carried out by (a) representing the list of terms as a first vector of terms, (b) determining for each of a plurality of database texts, a match score related to the number of terms present in or derived from that text that match those in the first vector, and (c) selecting one or more of the texts having the highest primary-vector match scores, where the first subset of terms includes terms present in at least one of the selected, highest match score texts in the first group of texts. The coefficient assigned to each term in the first vector may be related to the selectivity value determined for that term, calculated as the frequency of occurrence of that term in a library of texts in one field, relative to the frequency of occurrence of the same term in one or more other libraries of texts in one or more other fields, respectively, above a given threshold value.

The method may further include adjusting the effective coefficients assigned to selected terms in the first vector, based on user-input related to one or more user-selected terms. The search is then repeated with the adjusted-value vector, with increased probability that the selected term(s) in the list will be present in said first group of texts.

Similarly, the second search may be carried out by (a) forming a second vector of terms that are unrepresented or underrepresented in the highest ranked primary texts, (b) determining for each of a plurality of sample texts, a match score related to the number of terms present in or derived from that text that match those in the second vector, and (c) selecting one or more of the secondary texts having the highest secondary-vector match scores, where the second subset of terms includes terms present in at least one of the selected, highest match score texts in the second group of texts. The coefficients assigned to each term in the second vector is related to the selectivity value determined for that term, calculated as the frequency of occurrence of that term in a library of texts in one field, relative to the frequency of occurrence of the same term in one or more other libraries of texts in one or more other fields, respectively.

The method may further adjusting the effective coefficients assigned to selected terms in the second vector, based on user-input related to one or more user-selected terms. The search is then carried out with the adjusted-value vector, increasing the probability that the selected term(s) in the list will be present in the second group of texts.

The pairs of database texts presented to the user may have the highest overlap scores as determined from one or both of:
(1) overlap between descriptive terms in one text in the pair with descriptive terms in the other text in the pair; and
(2) overlap between descriptive terms present in at least one text in the pair and said list of descriptive terms;

Alternatively, the pairs of database texts presented to the user may have the highest overlap scores as determined from one or both of:
(3) for one or more terms in one of the pairs of texts identified as feature terms, the presence in the other pair of texts of one or more feature-specific terms defined as having a substantially higher rate of occurrence in a feature library composed in texts containing that feature term,
(4) for one or more attributes associated with the target invention, the presence in at least one text in the pair of attribute-specific terms defined as having a substantially higher rate of occurrence in an attribute library composed in texts containing a word-and/or word-group term that is descriptive of that attribute, and

Where overlap is based on feature terms, the method may operate, based on user-selection of one or more terms in the list of descriptive terms as feature terms, to determine, for each selected feature term, a feature-term selectivity value related to the occurrence of that term in the texts of the associated feature library relative to the occurrence of the same term in one or more different libraries of texts, and using the feature-term selectivity values so determined, to identify terms that are feature specific for the associated feature.

Where overlap is based on attribute terms, the method may operate, based on user-selection of one or more attribute terms desired in the concept, to determine, for each selected attribute term, an attribute-term selectivity value related to the occurrence of that term in the texts of the associated attribute library relative to the occurrence of the same term in one or more different libraries of texts, and using the attribute-term selectivity values so determined, to identify terms that are attribute specific for the associated attribute.

The target concept and the associated database searched may be selected from
(1) a novel combination of existing inventions, where the database searched in is a database of patent abstracts or claims;
(2) a discovery and one or more potential applications of the discovery, where the database searched is a database of patent abstracts or claims;
(3) a novel combination of storylines, wherein the database searched is a database of abstracts of stories.

In a related aspect, the invention includes an automated system for combining texts to form novel combinations of texts related to a desired target concept that is represented in the form of a natural-language text or a list of descriptive terms that include words and, optionally, word groups. The system includes a computer, a database of texts accessible by the computer that include texts related to the selected concept, and a computer readable code which is operable, under the control of said computer, to perform the above-described method steps.

Also forming part of the invention is a computer-readable code for use with an electronic computer and a database a of texts that include texts related to a selected concept, for combining texts to form novel combinations of texts related to the selected concept, where the concept is represented in the form of a natural-language text or a list of descriptive terms that include words and, and said code is operable, under the control of said computer, to perform the above-described method steps.

In still another aspect, the invention includes a feature or attribute descriptor dictionary having a list of feature and/or attribute descriptors, and for each descriptor, a list of word and/or word-group terms that are that are descriptor specific for that descriptor. A term is descriptor-specific for a given descriptor if the term has a substantially higher rate of occurrence in a descriptor library composed in texts containing a word-and/or word-group term that is the same as or descriptive of that descriptor than the same term has in a library of texts unrelated to that descriptor.

These and other objects and features of the invention will become more fully apparent when the following detailed description of the invention is read in conjunction with the accompanying drawings.

### BRIEF DESCRIPTION OF THE DRAWINGS

FIGS. 1A and 1B show, in flow-diagram form, steps in for forming a new invention or concept by combining features from existing inventions, according to one invention paradigm, (1A) and an information graph showing the various information contributions made by an inventor in generating the invention (1B);

FIGS. 2A and 2B show, in flow-diagram form, steps for adapting a discovery to novel applications, according to a similar invention paradigm, (2A) and an information graph showing the various information contributions made by an inventor in generating the invention (2B);

FIG. 3 illustrates components of the system of the invention;

FIG. 4 shows, in flow diagram form, an overview of the operation of the system of the invention;

FIG. 5 is a flow diagram of steps for processing a natural-language text;

FIG. 6 is a flow diagram of steps for generating a database of processed text files;

FIG. 7 is a flow diagram of steps for generating a word-records database;

FIG. 8 illustrates a portion of two word records in a representative word-records database;

FIG. 9 is a flow diagram of system operations for generating, from a word-records database, a list of target words with associated selectivity values (SVs), and identifiers;

FIGS. 10A and 10B are flow diagrams of system operations for generating, from the list of target words and associated a word-records from FIG. 9, a list of target word pairs and associated selectivity values and text identifiers;

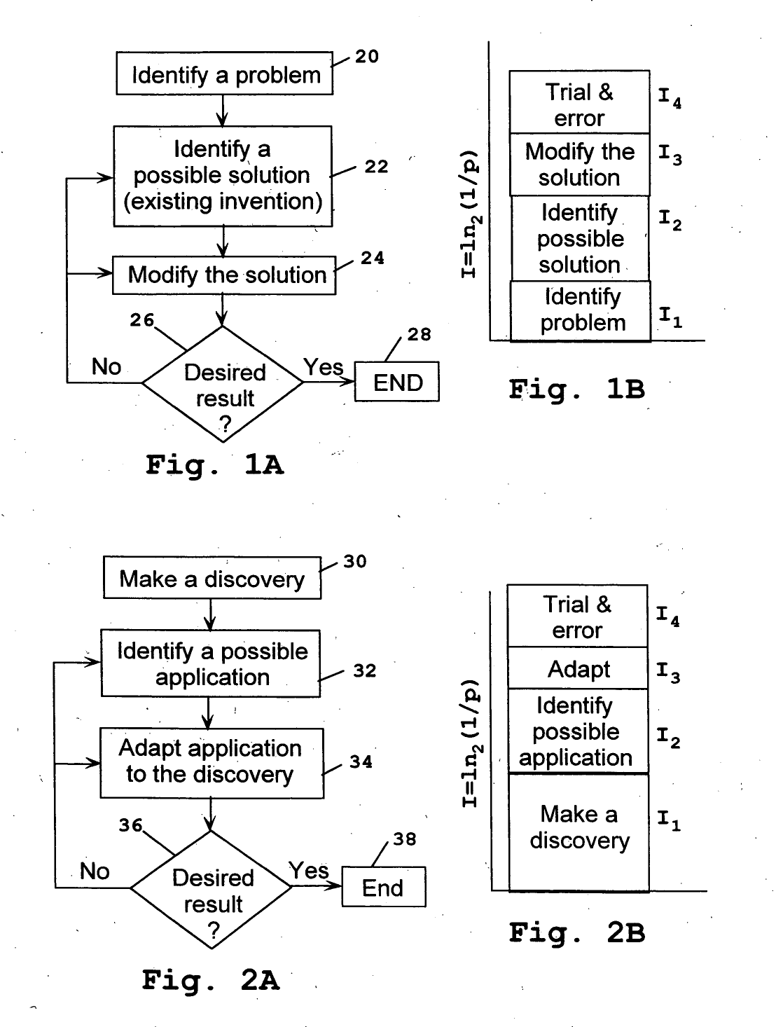

FIG. 1 1A is a flow diagram of system operations for calculating word inverse document frequencies (IDFs) for target words, and for generating a word-string vector representation of a target text, FIG. 11B shows an exemplary IDF function used in calculating word IDF values; and FIG. 11C shows how the search operation of the system may accommodate word synonyms;

FIG. 12 is a flow diagram of system operation for searching and ranking database texts;

FIG. 13 is a flow diagram of system operations for text matching based in a secondary text-matching search based on terms underrepresented in a primary text-matching search;

FIG. 14A is a flow diagram of feedback performance operations carried out by the system in refining a text-matching search, based on user selection of most pertinent texts;

FIG. 14B is a flow diagram of feedback performance operations carried out by the system in refining a text-matching search, based on user modification of of descriptive term weights;

FIG. 14C is a flow diagram of feedback performance operations carried out by the system in refining a text-matching search, based on user selection of most pertinent text class;

FIG. 15 shows, in flow diagram form, the operation of the system in ranking pairs of combined texts based on term overlap;

FIG. 16 shows, in flow diagram form, the operation of the system in ranking pairs of combined texts based on term coverage;

FIG. 17A is a flow diagram of the operation of the system in generating an attribute library;

FIG. 17B is a flow diagram of the operation of the system in generating a dictionary of attribute terms and an attribute library;

FIG. 17C is a flow diagram of operations for identifying highest-ranked attribute-specific terms;

FIG. 17D shows, in flow diagram form, the operation of the system in ranking pairs of combined texts based on one or more selected attributes;

FIG. 18 shows, in flow diagram form, the operation of the system in ranking pairs of combined texts based on reference citation scores;

FIG. 19 shows a graphical interface in the system of the invention for use in text searching to identify primary and secondary groups of texts;

FIG. 20 shows a graphical interface in the system of the invention for use combining and filtering pairs of texts, and

FIG. 21 shows a graphical interface in the system of the invention for use constructing filter libraries.

### DETAILED DESCRIPTION OF THE INVENTION

A. Definitions

“Natural-language text” refers to text expressed in a syntactic form that is subject to natural-language rules, e.g., normal English-language rules of sentence construction.

The term “text” will typically intend a single sentence that is descriptive of a concept or part of a concept, or an abstract or summary that is descriptive of a concept, or a patent claim of element thereof.

“Abstract” or “summary” refers to a summary, typically composed of multiple sentences, of an idea, concept, invention, discovery, story or the like. Examples, include abstracts from patents and published patent applications, journal article abstracts, and meeting presentation abstracts, such as poster-presentation abstracts, abstract included in grant proposals, and summaries of fictional works such as novels, short stories, and movies.

“Digitally-encoded text” refers to a natural-language text that is stored and accessible in computer-readable form, e.g., computer-readable abstracts or patent claims or other text stored in a database of abstracts, full texts or the like.

“Processed text” refers to computer readable, text-related data resulting from the processing of a digitally-encoded text to generate one or more of (i) non-generic words, (ii) wordpairs formed of proximately arranged non-generic words, (iii) word-position identifiers, that is, sentence and word-number identifiers.

A “verb-root” word is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language text that are not descriptive of, or only non-specifically descriptive of, the subject matter of the text. Examples include prepositions, conjunctions, pronouns, as well as certain nouns, verbs, adverbs, and adjectives that occur frequently in texts from many different fields. “Non-generic words” are those words in a text remaining after generic words are removed.

A “word group” is a group, typically a word pair, of non-generic words that are proximately arranged in a natural-language text. Typically, words in a word group are non-generic words in the same sentence. More typically they are nearest or next-nearest non-generic word neighbors in a string of non-generic words, e.g., a word string.

Words and optionally, words groups, usually encompassing non-generic words and wordpairs generated from proximately arranged non-generic words, are also referred to herein as “terms”.

“Field” refers to a given technical, scientific, legal or business field, as defined, for example, by a specified technical field, or a patent classification, including a group of patent classes (superclass), classes, or sub-classes.

“Library of texts in a field” refers to a library of texts (digitally encoded or processed) that have been preselected or flagged or otherwise identified to indicate that the texts in that library relate to a specific field or area of specialty, e.g., a patent class, patent subclass, or patent superclass. For example, a library may include patent abstracts from each of up to several related patent classes, from one patent class only, or from individual subclasses only. A library of texts typically contains at least 100 texts, and may contain up to 1 million or more.

A “field-specific selectivity value” for a word or word-group term is related to the frequency of occurrence of that term in a library of texts in one field, relative to the frequency of occurrence of the same term in one or more other libraries of texts in a field, where a field is defined as an area or branch or class of information, such as patent classes, different technical fields, and the like.

“Frequency of occurrence of a term (word or word group) in a library” is related to the numerical frequency of the term in the library of texts, usually determined from the number of texts in the library containing that term, per total number of texts in the library or per given number of texts in a library. Other measures of frequency of occurrence, such as total number of occurrences of a term in the texts in a library per total number of texts in the library, are also contemplated.

A “function of a selectivity value” a mathematical function of a calculated numerical-occurrence value, such as the selectivity value itself, a root (logarithmic) function, a binary function, such as “+” for all terms having a selectivity value above a given threshold, and “−” for those terms whose selectivity value is at or below this threshold value, or a step function, such as 0, +1, +2, +3, and +4 to indicate a range of selectivity values, such as 0 to 1, >1-3, >3-7, >7-15, and >15, respectively. One preferred selectivity value function is a root (logarithm or fractional exponential) function of the calculated numerical occurrence value. For example, if the highest calculated-occurrence value of a term is X, the selectivity value function assigned to that term, for purposes of text matching, might be X^{1/2} or X^{1/2.5}, or X^{1/3}. “Feature” refers to some a basic element, quality or attribute of a concept. For example, where the concept is an invention, the features may related to (i) the problem to be solved or the problem to be addressed by the invention, (ii) a critical method step or material for making the invention, or (iii) to an application or use of the invention. Where the concept is a scientific or technical concept, the features may be related to (i) a discovery underlying the concept, (ii) a principle underlying the concept, and (iii) a critical element or material needed in executing the concept. Where the concept is a story, e.g., a fictional account, the features may be related to (i) a basic plot or motif, (ii) character traits of one or more characters, and (iii) setting.

An “attribute” refers to a feature related to some quality or property or advantage of the concept, typically one that enhances the value of the concept. For example, in the case of an inventive concept, an attribute feature might be related to an unexpected result or an unsuggested property or advantage. In the case of a scientific concept, the property might be related to widespread acceptance, or value to other researchers. For a story concept, an attribute feature might be related to popular appeal or genre.

A “descriptor” refers to a feature or an attribute.

A “descriptor library of texts” or “descriptor library” refers to a collection of texts in a database of texts in which all of the texts contain one or more terms related to a specified descriptor, e.g., an attribute in an attribute library or a feature in a feature library. Typically, the descriptor (feature or attribute) is expressed as one or more words and/or word pairs, e.g., synonyms that represent the various ways that the particular descriptor might be expressed in a text. A descriptor attribute library is typically formed by searching a database of texts for those texts that contain a word or word group related to the descriptor, and is thus a subset of the database.

A descriptor “selectivity value”, that is, an attribute or feature selectivity value of a term in a descriptor library, is related to the frequency of occurrence of that term in the associated library, relative to the frequency of occurrence of the same term in one or more other libraries of texts, typically one or more other non-attribute or non-feature libraries. The measure of frequency of occurrence of a term is preferably the same for all libraries, e.g., the number of texts in a library containing that term. The descriptor selectivity value of a given term for a given field is typically determined as the ratio of the percentage texts in the descriptor library that contain that term, to the percentage texts in one or more other, preferably unrelated libraries that contain the same term. A descriptor selectivity value so measured may be as low as 0.1 or less, or as high as 1,000 or greater. The descriptor selectivity value of a term indicates the extent to which that term is associated with that descriptor.

A term is “descriptor-specific,” e.g., “attribute-specific” or “feature specific“for a given attribute or feature (descriptor) if the term has a substantially higher rate of occurrence in a descriptor library composed in texts containing a word- and/or word-group term that is descriptive of that preselected descriptor than the same term has in a library of texts unrelated to that descriptor. A typical measure of a term's descriptor's specificity is the term's descriptor selectivity value.

A “group of texts” or “combined group of texts” refers to two or more texts, e.g., summaries, typically one text from each of two or more different features libraries, although texts from the same library may also be combined to form a group of texts.

An “extended group of texts” refers to groups of texts that are themselves combined to produce combinations of combined groups of texts. For example, a group of texts composed of texts A, B may be combined with a group of texts c, d, to form an extended group of texts A, B, C, D.

A “text identifier” or “TID” identifies a particular digitally encoded or processed text in a database, such as patent number, assigned internal number, bibliographic citation or other citation information.

A “library identifier” or “LID” identifies the field, e.g., technical field patent classification, legal field, scientific field, security group, or field of business, etc. of a given text.

“A word-position identifier” of “WPID” identifies the position of a word in a text. The identifier may include a “sentence identifier” or “SID” which identifies the sentence number within a text containing a given word or word group, and a “word identifier” or “WID” which identifiers the word number, preferably determined from distilled text, within a given sentence. For example, a WPID of 2-6 indicates word position 6 in sentence 2. Alternatively, the words in a text, preferably in a distilled text, may be number consecutively without regard to punctuation.

A “database” refers to one or more files of records containing information about libraries of texts, e.g., the text itself in actual or processed form, text identifiers, library identifiers, classification identifiers, one or more selectivity values, and word-position identifiers. The information in the database may be contained in one or more separate files or records, and these files may be linked by certain file information, e.g., text numbers or words, e.g., in a relational database format.

A “text database” refers to database of processed or unprocessed texts in which the key locator in the database is a text identifier. The information in the database is stored in the form of text records, where each record can contain, or be linked to files containing, (i) the actual natural-language text, or the text in processed form, typically, a list of all non-generic words and word groups, (ii) text identifiers, (iii) library identifiers identifying the library to which a text belong, (iv) classification identifiers identifying the classification of a given text, and (v), word-position identifiers for each word. The text database may include a separate record for each text, or combined text records for different libraries and/or different classification categories, or all texts in a single record. That is, the database may contain different libraries of texts, in which case each text in each different-field library is assigned the same library identifier, or may contain groups of texts having the same classification, in which case each text in a group is assigned the same classification identifier.

A “word database” or “word-records database” refers to a database of words in which the key locator in the database is a word, typically a non-generic word. The information in the database is stored in the form of word records, where each record can contain, or be linked to files containing, (i) selectivity values for that word, (ii) identifiers of all of the texts containing that word, (iii), for each such text, a library identifier identifying the library to which that text belongs, (iv) for each such text, word-position identifiers identifying the position(s) of that word in that text, and (v) for each such text, one or more classification identifiers identifying the classification of that text. The word database preferably includes a separate record for each word. The database may include links between each word file and linked various identifier files, e.g., text files containing that word, or additional text information, including the text itself, linked to its text identifier. A word records database may also be a text database if both words and texts are separately addressable in the database.

A “correlation score” as applied to a group of texts refers to a value calculated from the function related to linking terms in the texts. The correlation score indicates the extent to which two or texts in a group of texts are related by common terms, common concepts, and/or common goals. A correlation score may be corrected, e.g., reduced in value, for other factors or terms.

A “concept” refers to an invention, idea, notion, storyline, plot, solution, or other construct that can be represented (expressed) in natural-natural text.

B. Paradigms for Concept Generation

New concepts can arise from a variety of sources, such as the discovery of new elements or principles, the discovery of interesting or unsuggested properties or features or materials or devices, or the rearranging of elements in new ways to perform novel functions or achieve novel results.

An invention paradigm that enjoys wide currency is illustrated, in very general form in the flow diagram shown in FIG. 1A. This paradigm has particular relevance for the type of invention in which two or more existing inventions (or concepts) are combined to solve a specific problem. The user first selects a problem to be solved (box 20). The problem may be one of overcoming an existing limitation in the prior art, improving the performance of an existing invention, or achieving an entirely novel result. As a first step in solving the problem, the user will try to find, among all possible solutions, e.g., existing inventions, one primary reference or invention that can be modified or otherwise adapted to solve the problem at hand. Typically, the inventor will approach this task by drawing on experience and personal knowledge to identify a possible existing solution that represents “a good place to start” in solving the problem.

Once this initial starting point has been identified, the user attempts to adapt the existing, selected invention to the problem at hand. That is, the inventor modifies the solution (box 24) in its structural or operational features, so that the selected invention is capable of solving the new problem. In performing this step, the inventor is likely to draw on personal knowledge of the field of the invention, to “discover” one or more possible modifications that would solve the problem at hand.

Typically, the user will repeat the selection/modifications steps above, either by actual or conceptual trial and error, until a good solution is found, indicated by logic box 26. When the desired result is achieved, the inventing is at an end (box 38), even though additional work may remain in refining or commercializing the invention.

The bar graph in FIG. 1B shows typical information contributions at each stage of the inventing process. The measure of information used here is taken from information theory, which expresses information in the form I=ln₂(1/P), where P is the probability that a particular event will be selected. For example, in the step of identifying the problem to be solved, it is assumed that the inventor selects the problem out of N possible problems. The probability P of selecting this problem is then 1/N, and the information needed to make this selection l₁=ln₂N. As can be appreciated, this measure of information reflects the number of “yes-no” questions would be required to pick the desired solution out of N possible solution. The actual amount of information needed to identify a given problem (l₁ in FIG. 1 B) may be relatively trivial for an obvious or widely recognized problem, or might be high for a previously unidentified, or otherwise nonobvious new problem.

The information l₂ needed to identify an initial “starting-point” solution is similarly determined as the log₂ of the number of different existing inventions or concepts one might select from to form the starting point of the solution. Since the number of possible solutions tends to be quite large as a rule, the information contribution of this step is indicated as being relatively high. The graph similarly shows the information contributions l₃ and l₄ for modifying the starting-point solution and the trail and error phase of the invention. In each case, the information contribution reflects the number of possible choices or selections needed to arrive, ultimately, at a desired solution.

If two or more separate events, such as the various inventive activities just described, have individual probabilities of, say, P₁, P₂, P₃, and P₄, the total probability of the combined event is just their product, e.g., P₁* P₂*P₃,*P₄. A useful property of a In function as a measure of information is that the information contributions making up the invention are additive, since In N₁*N₂=ln N₁+ln N₂. In the present case, the information contributions from P₁, P₂, P₃, and P₄ of making a combination type invention can be expressed as the sum of individual information contributions, that is l₁+l₂+l₃+l₄, as shown in FIG. 1B.

Another general type of invention arises from new discoveries, such as observations on natural phenomena, or data generated by systematic experimental studies. Examples that one might mention are: the discovery of a material with novel properties, the discovery of novel drug interactions in biological systems, a discovery concerning the behavior of fluids under novel flow conditions, a novel synthetic reaction, or the observation a novel self-assembling property of a material, among many examples. In each case, the discovery was unpredictable from then-known laws of nature, or explainable only with the benefit of hindsight.

When a discovery is made, one typical looks for ways of applying the discovery to real-world problems. An invention paradigm that may be useful in examining the inventive activity that takes place between a discovery and a fully realized application is shown in flow-diagram form in FIG. 2A. Once the discovery is made (box 30), the inventor looks for possible applications, meaning references or inventions that might be able to profit from the discovery. Sometimes, as in the case of a novel drug interaction with a biological system, one or more applications will be readily apparent to the discoverer. In other cases, e.g., the discovery of a self-assembly property of a material or molecule, possible applications may be relatively obscure. In either case, once one or more possible applications are identified (box 32), the inventor must then adapt the discovery to the application (or adapt the application to the discovery), as at 34.

As examples of such an adaptation, an element or material with a newly discovered property may be substituted for an existing element or material, to enhance the performance of an existing invention; an existing device may be reduced in scale to realize newly-discovered fluid-flow property; the pressure or temperature of operation of an existing method or device may be varied to realize a newly-discovered property or behavior; or an existing compound developed as a novel therapeutic agent, based on a newly discovered product. Once a possible application is identified, the inventor may need to modify or adapt the application to the discovery (or the discovery to the application), requiring the selection of yet another part of the solution.

As in the first paradigm, the user will typically repeat the selection/modifications steps, either by actual or conceptual trial and error, until a good solution is found, indicated by logic box 36, and when a desired application is developed, the inventing may be complete, or the inventor can repeat the process anew for yet further applications.

The bar graph in FIG. 2B shows typical information contributions at each stage of the inventing process. Since the discovery itself is typically a low-probability event, made from a very large collection N of possible discoveries, the information l₁ required for the discovery is typically the largest information component. Each of the remaining activities, in turn, requires selection of a “solution” out of a plurality of possible choices, each being expressed as an information component l₂, l₃ and l₄, as indicated in the figure, where the total information required to make the discovery and apply it successfully is the sum of the information components.

This discussion of human mental and experimental activities required in concept generation, e.g., inventing, will set the stage for the discussion below on machine-assisted invention. In particularly, the system and method to be described are intended to assist in certain of the invention tasks outlined above, with the result that the human inventor can reach the same or even better end point with a substantially lower information input. The information difference is, as will be seen, supplied by various text-mining operations carried out by the system and designed to (i) identify descriptive word and word-group terms in natural-language texts, (ii) locate pertinent texts, and (iii) generate pairs of texts based on various types of statistically significant (but generally hidden) correlations between the texts.

Finally, it will be appreciated the notion of human invention as a series of probabilistic events will apply to many other forms of human creative activity. For example, a scientist might naturally employ one or both of the invention paradigms above to design experiments, or test hypotheses, or apply new discoveries. Similarly, a writer of fiction might start off with a general plot, and fill in details of the plot by piecing together plots or character actions from a variety of different sources.

C. System and Method Overview

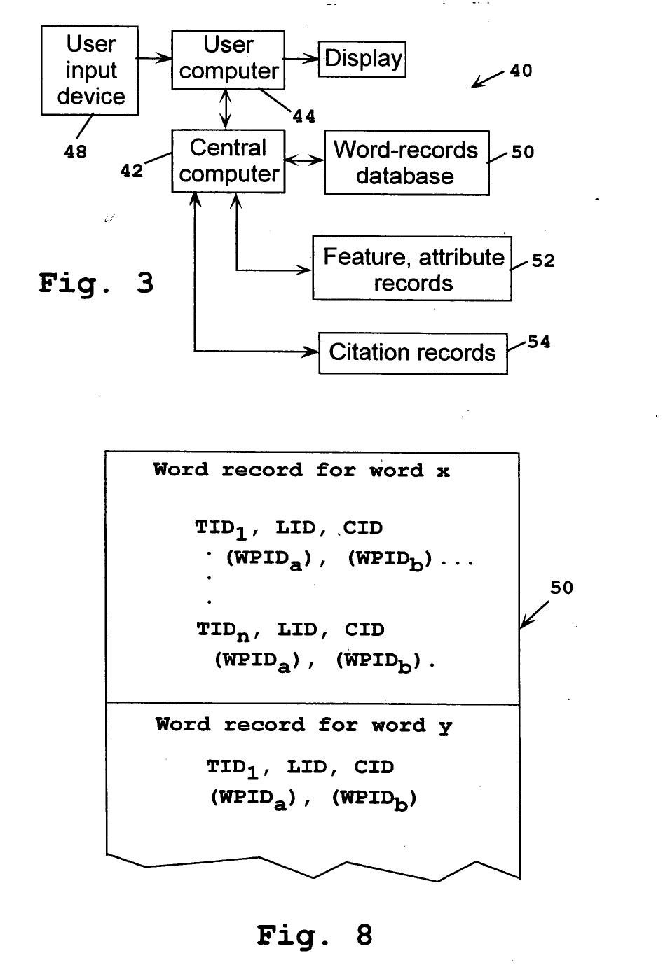

FIG. 3 shows the basic components of a text processing system 40 for assisting a user in generating new concepts in accordance with the present invention. A central computer or processor 42 receives user input and user-processed information from a user computer 44. The user computer has a user-input device 48, such as a keyboard, modem, and/or disc reader, by which the user can enter target text, refine search results, and guide certain correlation operations. A display or monitor 49 displays word, wordpair, search, and classification information to the user.

A word-records database 50 in the system is accessible by the central computer in carrying out operations of the system, as will be described. The system may also include a text database (not shown) used in performing certain operations described below. The system may also provide feature and/or attribute records 52, and citation records 54, each of which are accessible by the central computer in carrying out certain text correlation operations, also as described below.

It will be understood that “computer,” as used herein, includes both computer processor hardware, and the computer-readable code that controls the operation of the computer to perform various functions and operations as detailed below. That is, in describing program functions and operations, it is understood that these operations are embodied in a machine-readable code, and this code forms one aspect of the invention.

In a typical system, the user computer is one of several remote access stations, each of which is operably connected to the central computer, e.g., as part of an Internet or intranet system in which multiple users communicate with the central computer. Alternatively, the system may include only one user/central computer, that is, where the operations described for the two separate computers are carried out on a single computer.

FIG. 4 shows in overview, the operation of the system in assisting a user in generating new concepts or inventions. The user input 48a in the system is typically a short description of a concept or idea that the user wishes to “develop” in terms of more specific elements, operational features or results. For example, the user might input a hypothetical invention, describing in general terms, how the invention might work and what it might achieve. In terms of the invention paradigm shown in FIG. 1 A, the input corresponds to the step of “identifying a problem” to be solved.

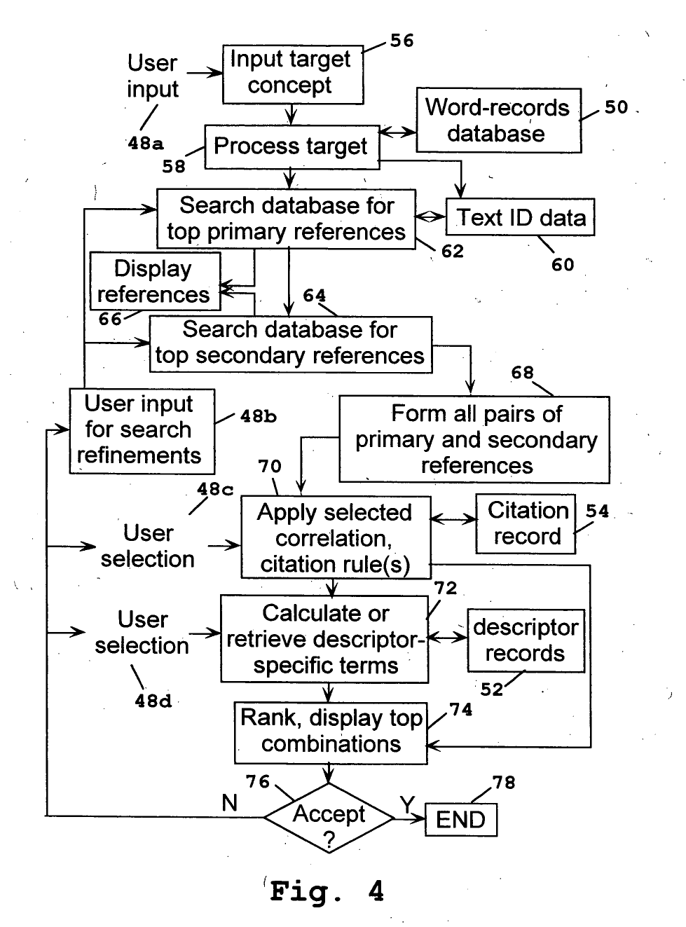

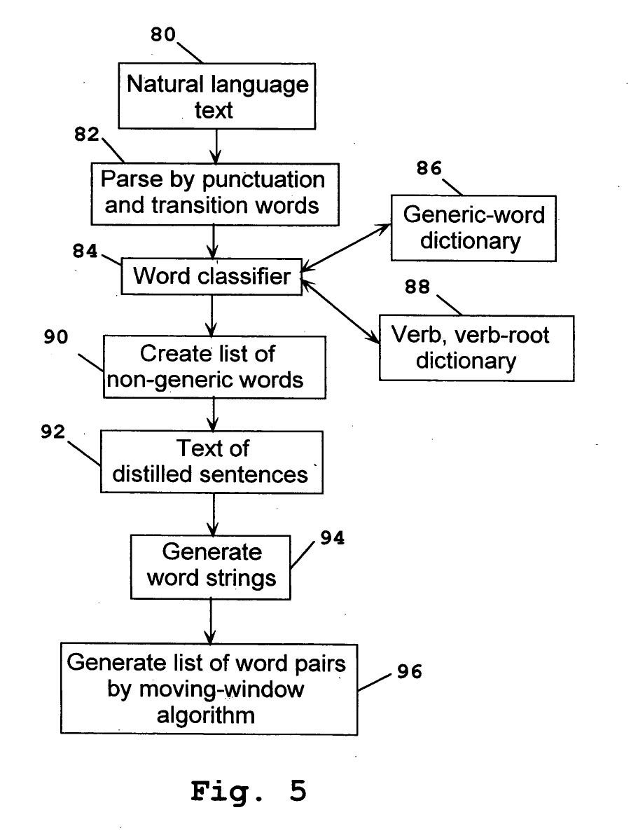

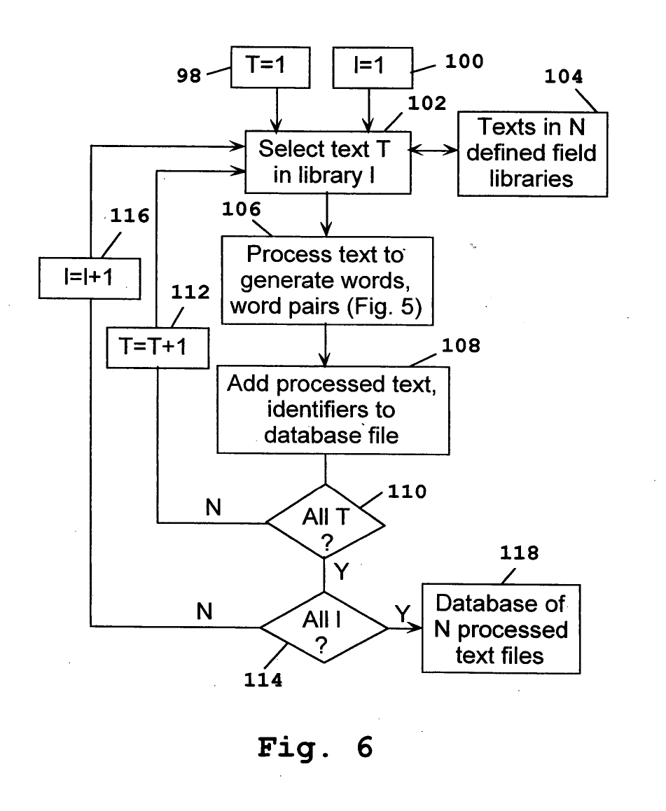

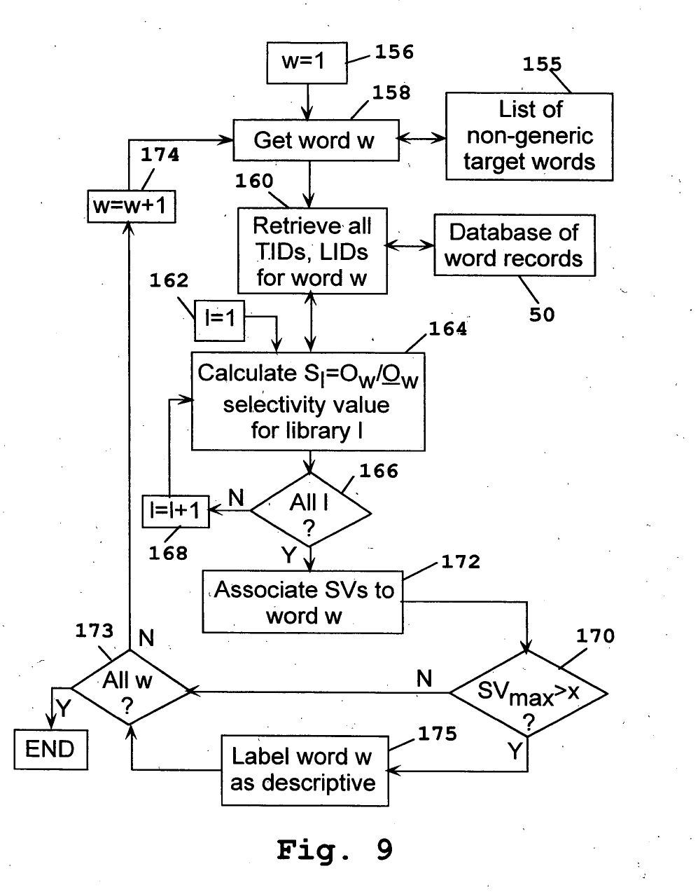

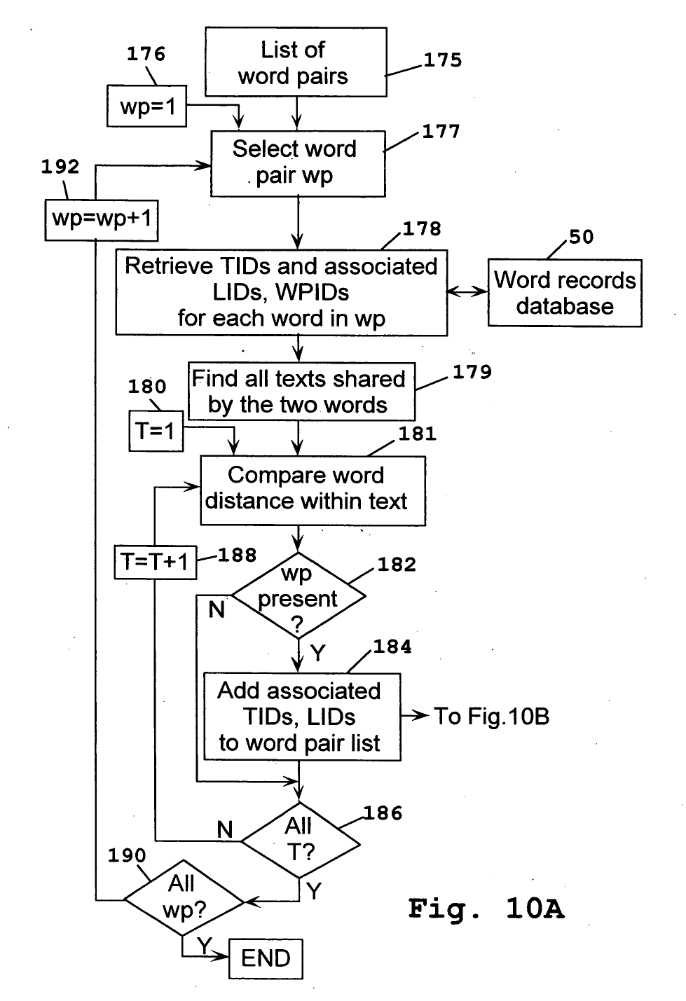

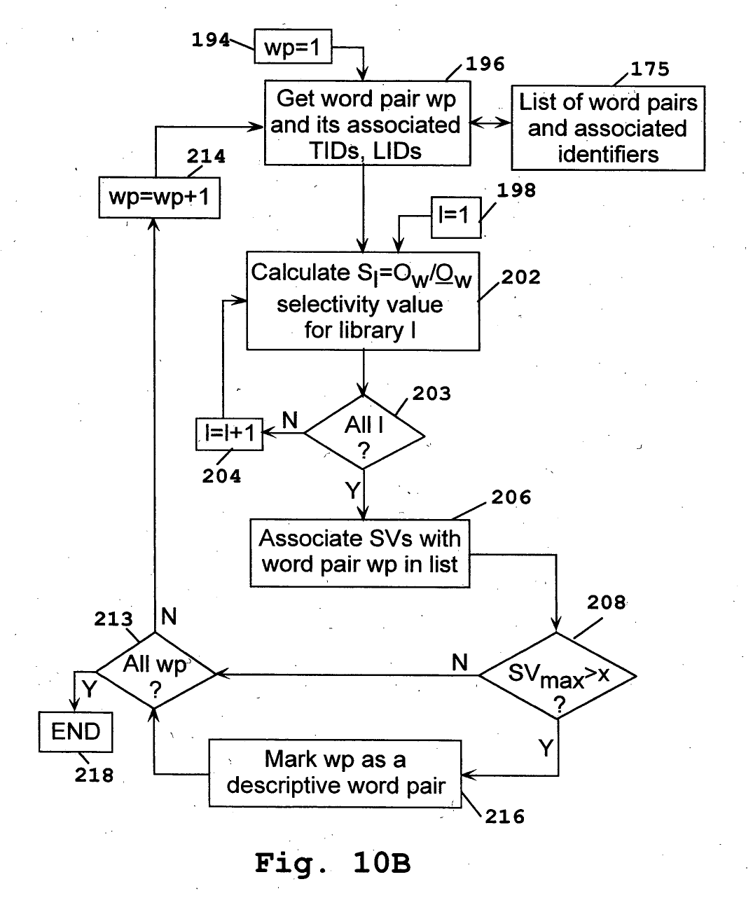

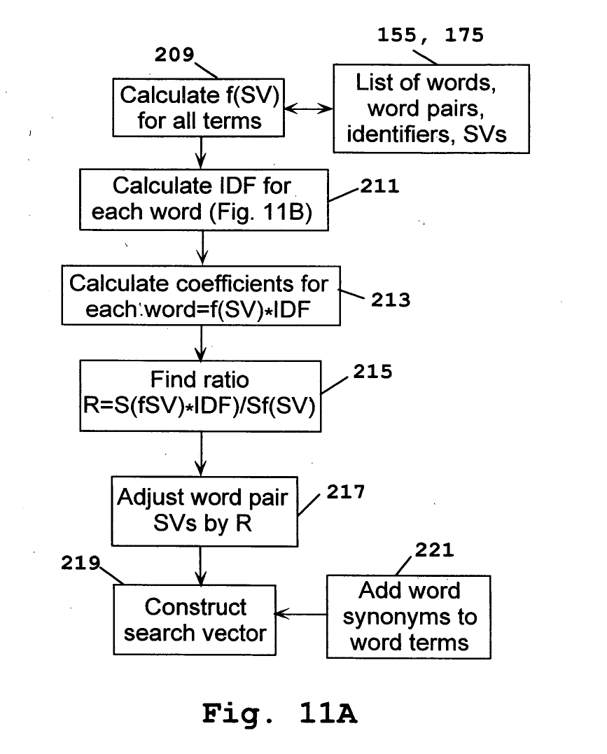

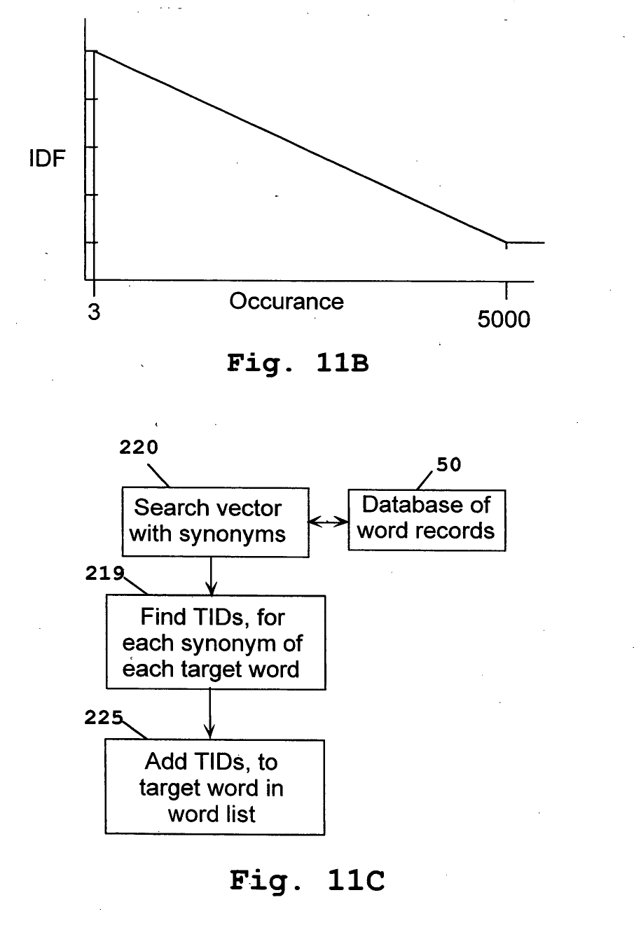

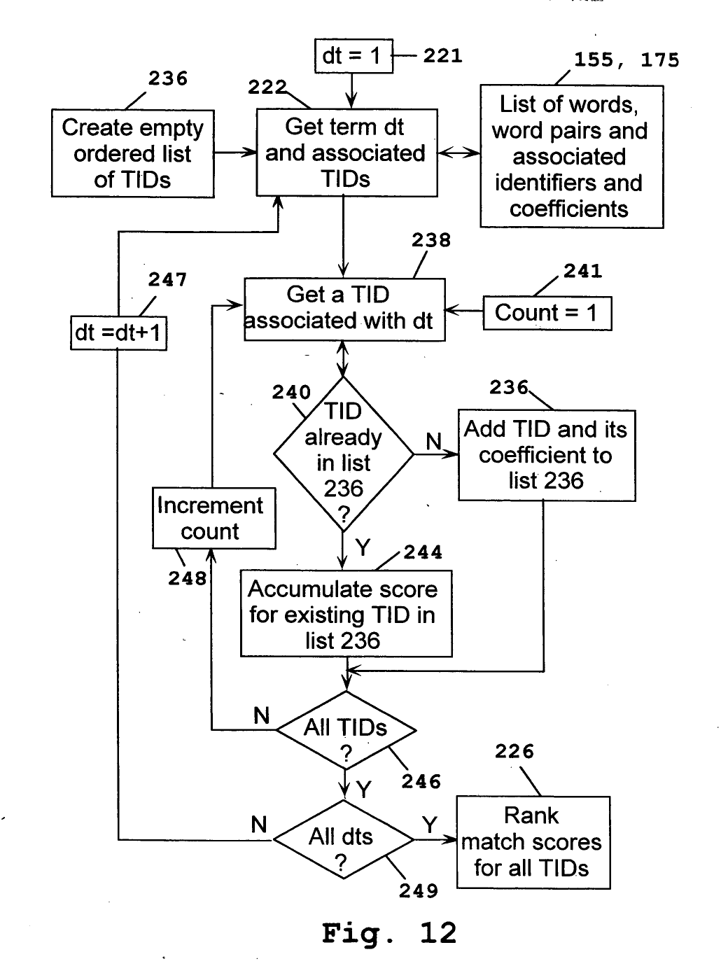

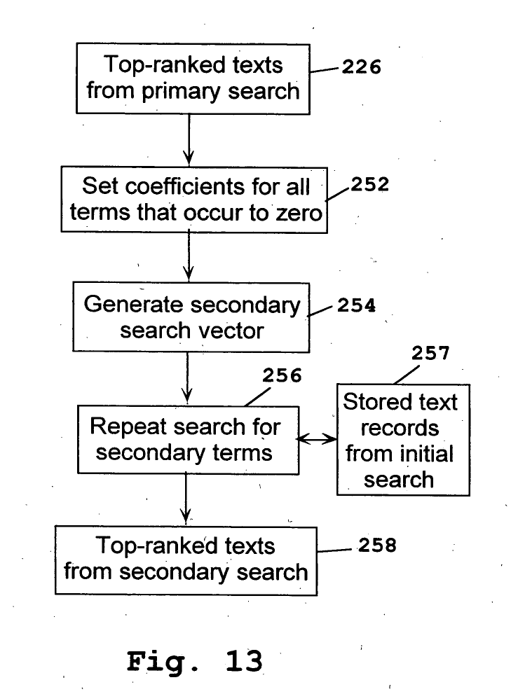

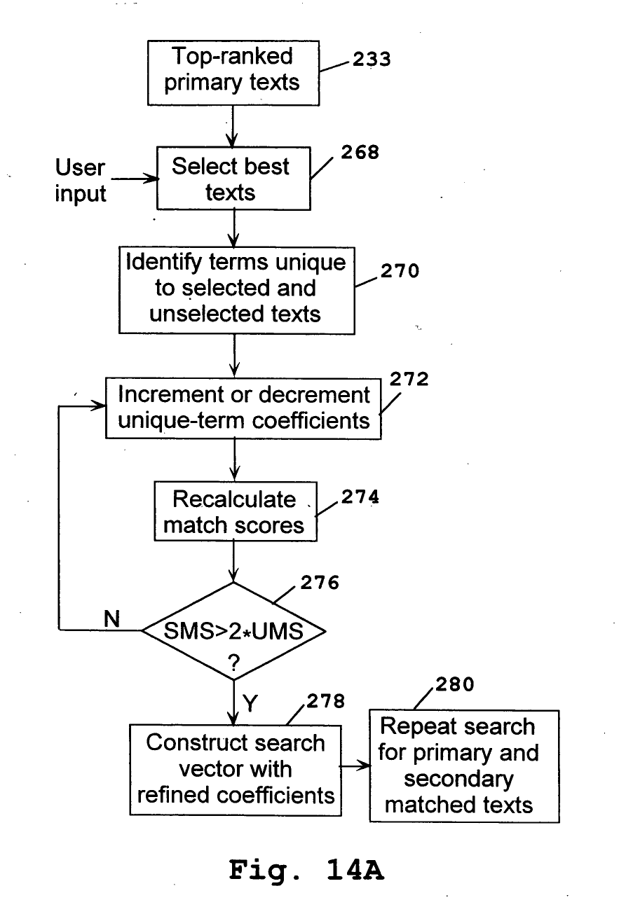

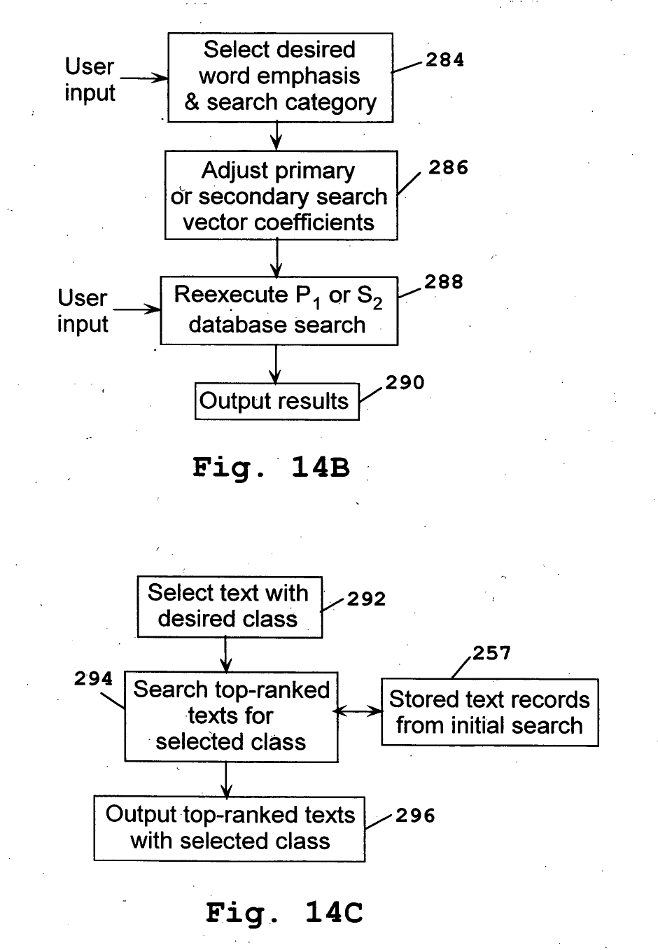

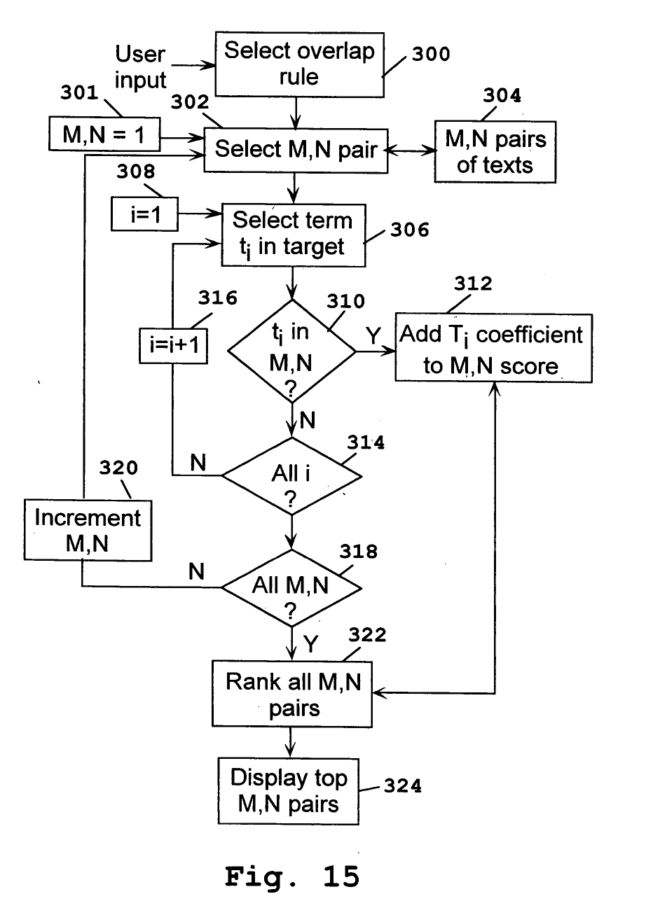

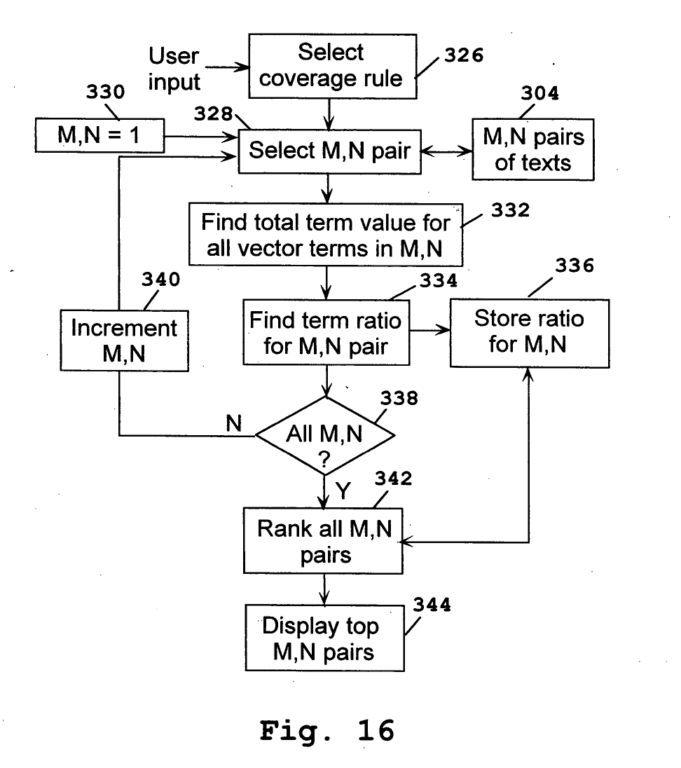

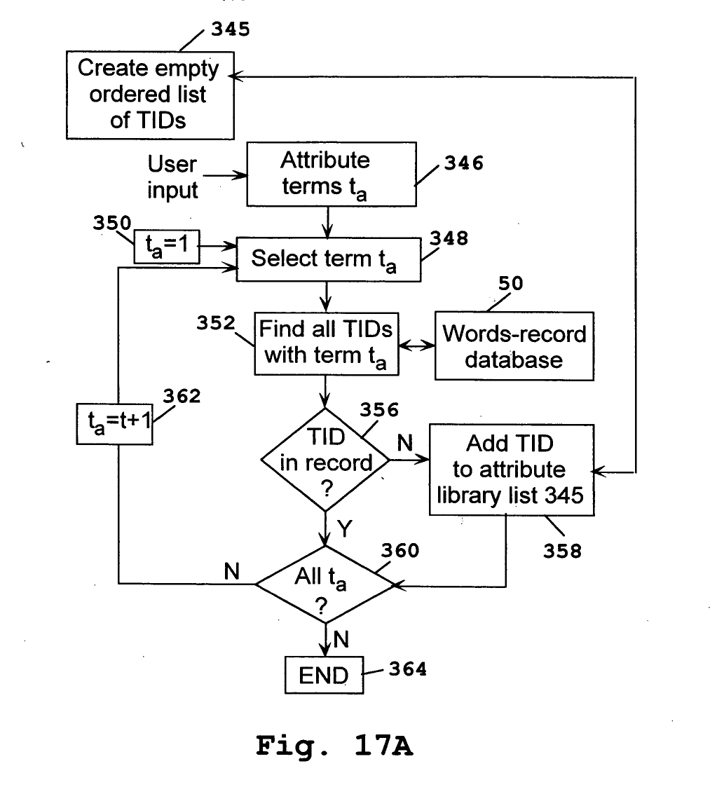

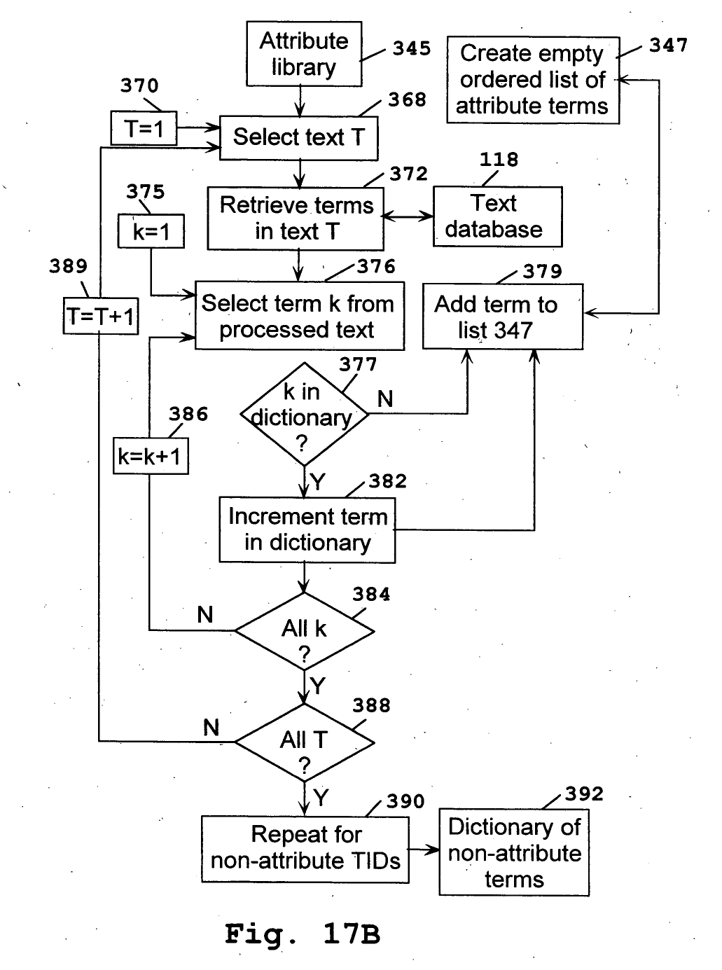

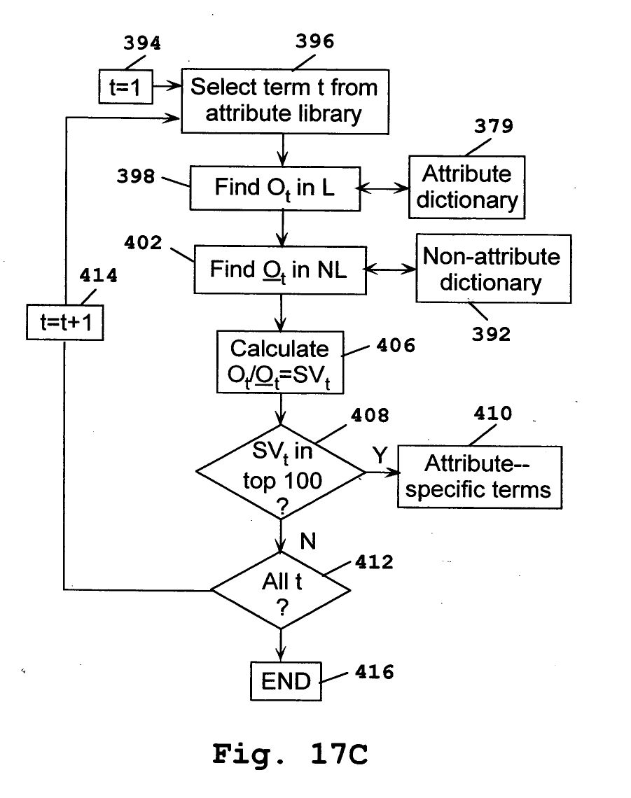

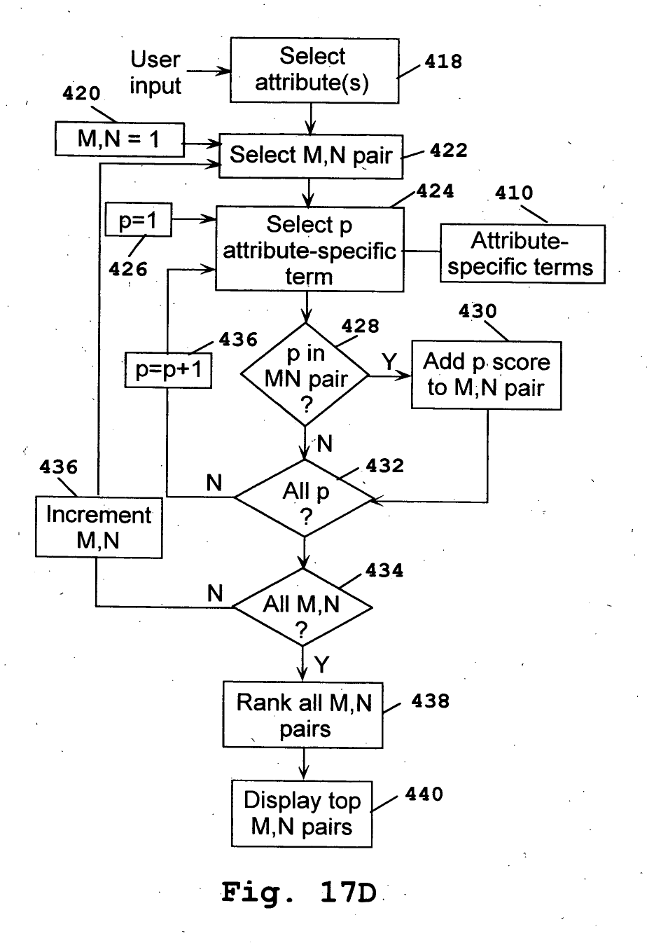

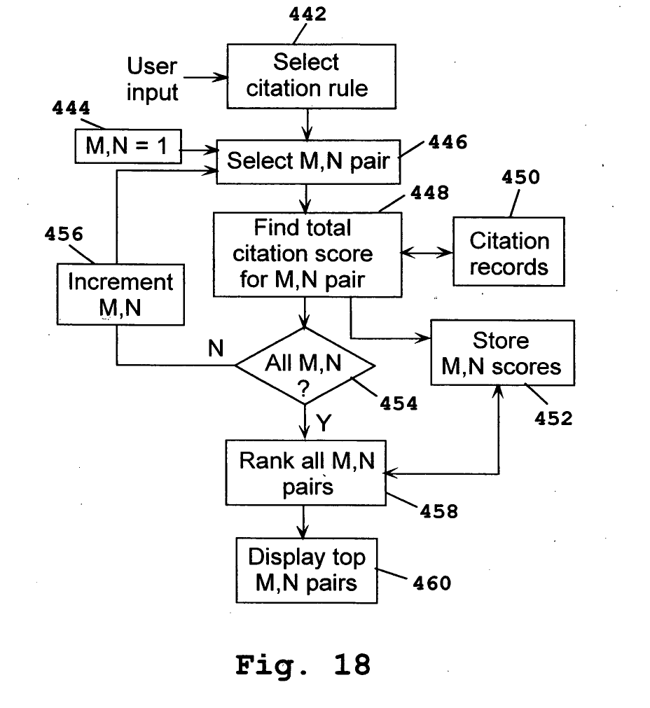

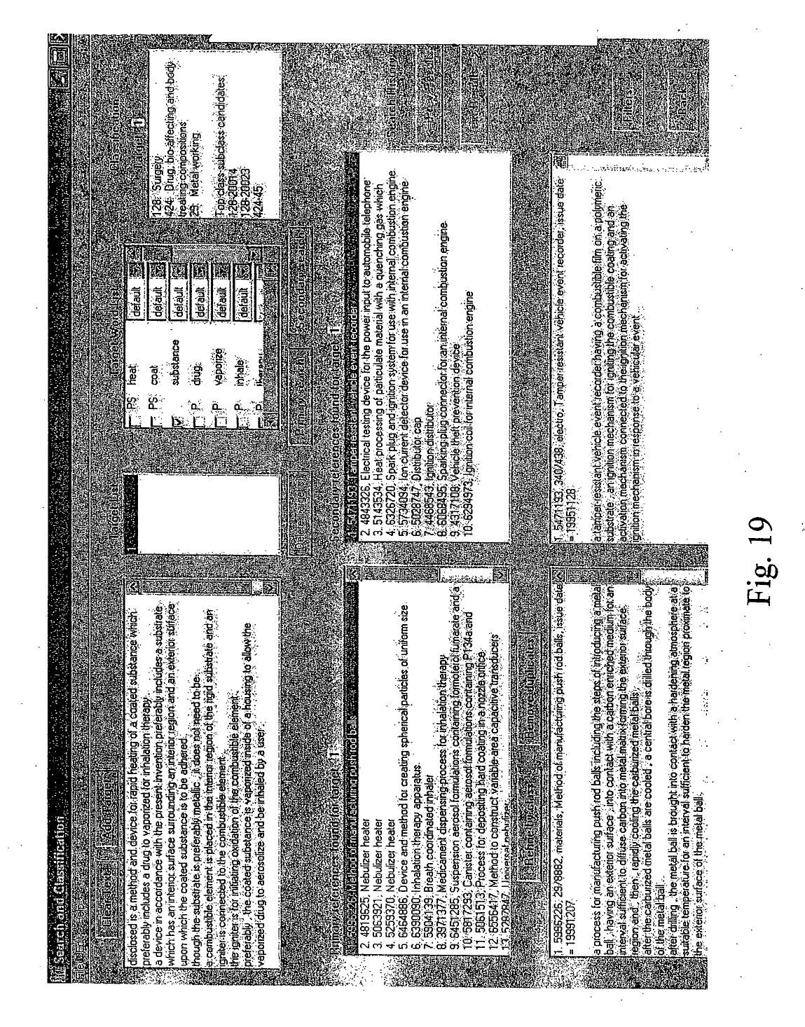

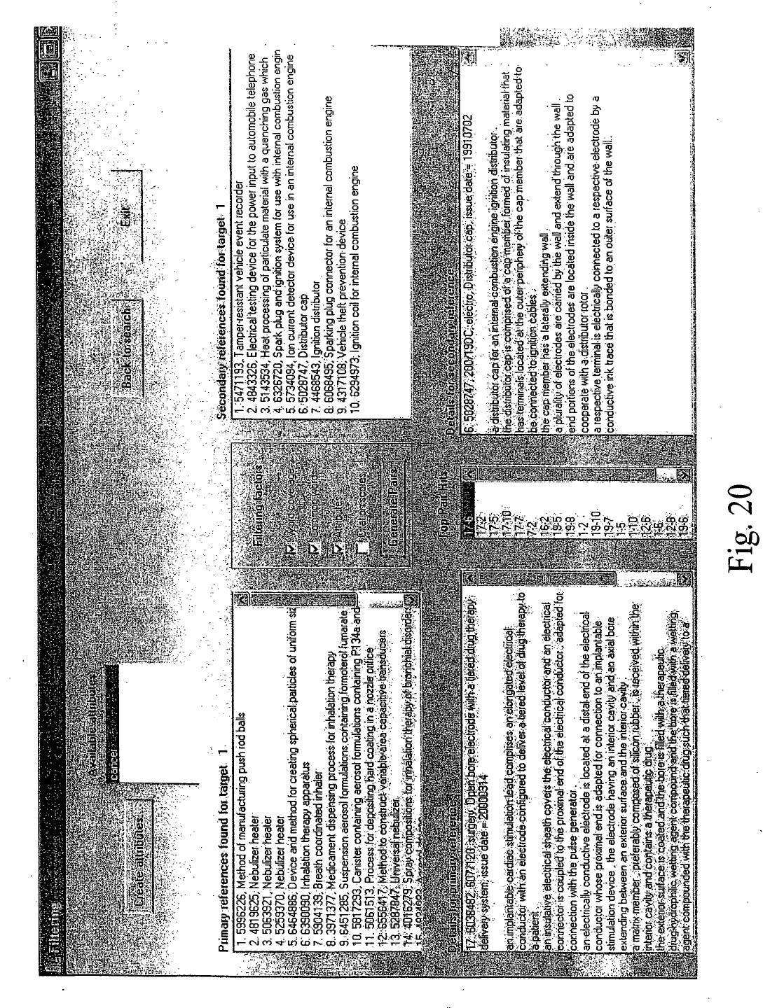

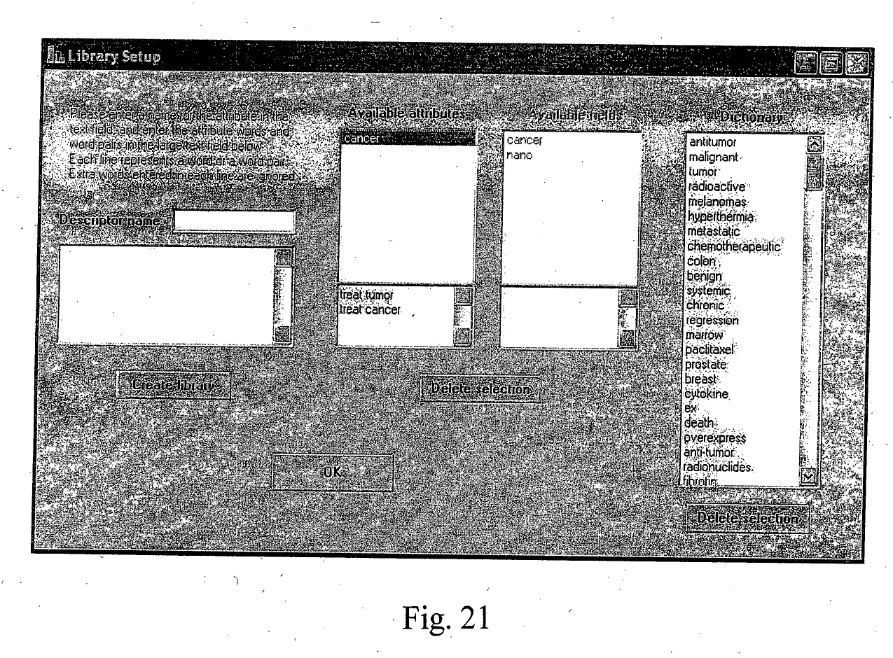

Alternatively, the user might simply have a list of “elements,” in the form of word and/or word-pair terms, that he/she wishes to employ in a new invention, in which case the input might be simply the list of terms.

Where the target input is a natural-language text describing a desired invention or concept, as at 56, the system will process the target text at 58, as described below with respect to FIG. 5, and interact with a word-records database, as described below with respect to FIGS. 9 and 10, to identify descriptive words (FIG. 9) and word-pairs (FIGS. 10A and 10B) in the text.

Whether the input is a natural-language text or series of terms, the program identifies a term as “descriptive” if its rate of occurrence in a library of texts in one field, relative to its occurrence in a library of texts in another field (the term's selectivity value) is above a given threshold value, as described below with respect to FIG. 9, for descriptive words, and in FIGS. 10A and 10B, for descriptive word pairs. As part of the process of identifying descriptive terms, the program looks up and in word-records database 50, and stores at 60, the TIDs associated with each descriptive term.

The program now constructs a vector representing the descriptive words in the target as a sum of terms (the coordinates of the vector), where the coefficient assigned to each term is related to the associated selectivity value of that term, and in the case of a word term, may also be related to the word's inverse document frequency, as described below with respect to FIGS. 11A-11C.

As shown at 62 and 64, a database of target-related texts is searched to identify a primary group of texts having highest term match scores with a first subset of the concept-related descriptive terms, and then searched again to identify a secondary group of texts having the highest term match scores with a second subset of the concept-related descriptive terms, where the first and second subsets are at least partially complementary with respect to the terms in the list. In a typical operation, described below with respect to FIG. 13, target vector terms that appear at least one time in the top N, e.g., top 20 matches, constitute the first subset of descriptive terms. The remaining terms, from which the secondary-search vector is formed, constitute the second subset of terms.

User input shown at 48b allows the user to adjust the weight of terms in either the primary or secondary search. For example, the user might want to emphasize or de-emphasize a word in either the first or second subset, cancel the word entirely, or move a term from the primary list to the secondary list or vice versa. Following this input, the use can instruct the program to repeat the primary and/or secondary search. The purposes of this user input is to adjust vector term weights to produce search results that are closer in concept or otherwise more pertinent to the target input. As will be seen below, the user may select other search refinements, e.g., to select only those primary or secondary references in a given class, or to refine the search vector based on user selection of “more pertinent” and “less pertinent” top ranked texts.

At this stage, the program takes the top ranked primary and secondary references (from an initial or refined search) and forms pairs of the texts (box 68), each pair typically containing one primary and one secondary reference. Thus, for example, if the program stored the top 20 matches for both primary and secondary searches, the program could form a total of 20×19/2=190 pairs of texts, each pair representing a potential “solution” to the problem posed in the target, that is, a primary, starting point solution, and a modification represented by the secondary reference.

To find the most promising of these many possible solutions, the program is designed to filter the pairs of texts by any one or more of several of criteria that are selected by the user (or may be preselected in a default mode). The criteria include term overlap -the extent to which the terms in one text overlap with those in the second text-or term coverage the extent to which the terms in both texts overlap with the target vector terms.

Alternatively, at indicated at box 70, user selection at 48c leads to filtering based on the quality of one or both texts in a pair, as judged for example, by the number of times a text has been cited. To this end, the program consults, for each text in a pair, a citation record 54 which includes citation scores for all of the TIDs or the top-ranked TIDs in the word-records database.

In still another embodiment, user selection at 48d can be used to rank pairs of text on the basis of features or attributes (descriptors) specified by the user. The portion of the program that executes this filter is shown at 72 and described in greater detail below with respect to FIGS. 17-19. Records of descriptor-specific terms used in this filter are stored at 52. Typically, these records are generated in response to specific descriptors provided by the user in advance, as will be seen. In general, the filter score will be based on (i) for one or more terms in one of the pairs of texts identified as feature terms, the presence in the other pair of texts of one or more feature-specific terms defined as having a substantially higher rate of occurrence in a feature library composed in texts containing that feature term, and (ii) for one or more attributes associated with the target invention, the presence in at least one text in the pair of attribute-specific terms defined as having a substantially higher rate of occurrence in an attribute library composed in texts containing a word-and/or word-group term that is descriptive of that attribute.

Following each filtering operation (or combined filtering operations), the top-ranked pairs of primary and secondary texts are displayed at 74 for user evaluation. As indicated by logic box 76, the user may either accept one or more pairs, as a promising invention or solution, or return the program to its search mode or one of the additional pair filters. This process is repeated until the user finally accepts the paired-text output, as 78.

D. Text processing

There are two related text-processing operations employed in the system. The first is used in processing each text in one of the N defined-field or defined-descriptor libraries into a list of words and, optionally, wordpairs that are contained in or derivable from that text. The second is used to process a target text into meaningful search terms, that is, descriptive words, and optionally, wordpairs. Both text-processing operations use the module whose operation is shown in FIG. 5. The text input is indicated generically as a natural language text 80 in FIG. 5.

The first step in the text processing module of the program is to “read” the text for punctuation and other syntactic clues that can be used to parse the text into smaller units, e.g., single sentences, phrases, and more generally, word strings. These steps are represented by parsing function 82 in the module. The design of and steps for the parsing function will be appreciated form the following description of its operation.

For example, if the text is a multi-sentence paragraph, the parsing function will first look for sentence periods. A sentence period should be followed by at least one space, followed by a word that begins with a capital letter, indicating the beginning of the next sentence, or should end the text, if the final sentence in the text. Periods used in abbreviations can be distinguished either from an internal database of common abbreviations and/or by a lack of a capital letter in the word following the abbreviation.

Where the text is a patent claim, the preamble of the claim can be separated from the claim elements by a transition word “comprising” or “consisting” or variants thereof. Individual elements or phrases may be distinguished by semi-colons and/or new paragraph markers, and/or element numbers of letters, e.g., 1, 2, 3, or i, ii, iii, or a, b, c.

Where the texts being processed are library texts, and are being processed, for constructing a text database (either as a final database or for constructing a word-record database), the sentences, and non-generic words (discussed below) in each sentence are numbered, so that each non-generic word in a text is uniquely identified by an a TID, an LID, and one or more word-position identifiers (WPIDs).

In addition to punctuation clues, the parsing algorithm may also use word clues. For example, by parsing at prepositions other than “of”, or at transition words, useful word strings can be generated. As will be appreciated below, the parsing algorithm need not be too strict, or particularly complicated, since the purpose is simply to parse a long string of words (the original text) into a series of shorter ones that encompass logical word groups.

After the initial parsing, the program carries out word classification functions, indicated at 84, which operate to classify the words in the text into one of three groups: (i) generic words, (ii) verb and verb-root words, and (iii) remaining groups, i.e., words other than those in groups (i) or (ii), the latter group being heavily represented by non-generic nouns and adjectives.

Generic words are identified from a dictionary 86 of generic words, which include articles, prepositions, conjunctions, and pronouns as well as many noun or verb words that are so generic as to have little or no meaning in terms of describing a particular invention, idea, or event. For example, in the patent or engineering field, the words “device,” “method,” “apparatus,” “member,” “system,” “means,” “identify,” “correspond,” or “produce” would be considered generic, since the words could apply to inventions or ideas in virtually any field. In operation, the program tests each word in the text against those in dictionary 86, removing those generic words found in the database.

As will be appreciated below, “generic” words that are not identified as such at this stage can be eliminated at a later stage, on the basis of a low selectivity value. Similarly, text words in the database of descriptive words that have a maximum value at of below some given threshold value, e.g., 1.25 or 1.5, could be added to the dictionary of generic words (and removed from the database of descriptive words).

A verb-root word is similarly identified from a dictionary 88 of verbs and verb-root words. This dictionary contains, for each different verb, the various forms in which that verb may appear, e.g., present tense singular and plural, past tense singular and plural, past participle, infinitive, gerund, adverb, and noun, adjectival or adverbial forms of verb-root words, such as announcement (announce), intention (intend), operation (operate), operable (operate), and the like. With this database, every form of a word having a verb root can be identified and associated with the main root, for example, the infinitive form (present tense singular) of the verb. The verb-root words included in the dictionary are readily assembled from the texts in a library of texts, or from common lists of verbs, building up the list of verb roots with additional texts until substantially all verb-root words have been identified. The size of the verb dictionary for technical abstracts will typically be between 500-1,500 words, depending on the verb frequency that is selected for inclusion in the dictionary. Once assembled, the verb dictionary may be culled to remove words in generic verb words, so that words in a text are classified either as generic or verb-root, but not both.

In addition, the verb dictionary may include synonyms, typically verb-root synonyms, for some or all of the entries in the dictionary. The synonyms may be selected from a standard synonyms dictionary, or may be assembled based on the particular subject matter being classified. For example, in patent/technical areas, verb meanings may be grouped according to function in one or more of the specific technical fields in which the words tend to appear. As an example, the following synonym entries are based a general action and subgrouped according to the object of that action:
create/generate,
   assemble, build, produce, create, gather, collect, make,
   generate, create, propagate,
   build, assemble, construct, manufacture, fabricate, design, erect,
prefabricate,
   produce, create,
   replicate, transcribe, reproduce, clone, reproduce, propagate, yield,
produce, create,
   synthesize, make, yield, prepare, translate, form, polymerize,
   join/attach,
   attach, link, join, connect, append, couple, associate, add, sum,
concatenate, insert,
   attach, affix, bond, connect, adjoin, adhere, append, cement, clamp, pin,
rivet, sew,
   solder, weld, tether, thread, unify, fasten, fuse, gather, glue, integrate,
   interconnect, link, add, hold, secure, insert, unite, link, support, hang,
hinge, hold,
   immobilize, interconnect, interlace, interlock, interpolate, mount, support),
   derivatize, couple, join, attach, append, bond, connect, concatenate, add,
link, tether,
   anchor, insert, unite, polymerize,
   couple, join, grip, splice, insert, graft, implant, ligate, polymerize, attach

As will be seen below, verb synonyms are accessed from a dictionary as part of the text-searching process, to include verb and verb-word synonyms in the text search.

The words remaining after identifying generic and verb-root words are for the most part non-generic noun and adjectives or adjectival words. These words form a third general class of words in a processed text. A dictionary of synonyms may be supplied here as well, or synonyms may be assigned to certain words on as as-needed basis, i.e., during classification operations, and stored in a dictionary for use during text processing. The program creates a list 90 of non-generic words that will accumulate various types of word identifier information in the course of program operation.

The parsing and word classification operations above produce distilled sentences, as at 92, corresponding to text sentences from which generic words have been removed. The distilled sentences may include parsing codes that indicate how the distilled sentences will be further parsed into smaller word strings, based on preposition or other generic-word clues used in the original operation. As an example of the above text parsing and word-classification operations, consider the processing of the following patent-claim text into phrases (separate paragraphs), and the classification of the text words into generic words (normal font), verb-root words (italics) and remainder words (bold type).

A device for monitoring heart rhythms, comprising:
means for storing digitized electrogram segments including signals indicative of depolarizations of a chamber or chamber of a patient's heart;
means for transforming the digitized signals into signal wavelet coefficients;
means for identifying higher amplitude ones of the signal wavelet coefficients; and
means for generating a match metric corresponding to the higher amplitude ones of the signal wavelet coefficients and a corresponding set of template wavelet coefficients derived from signals indicative of a heart depolarization of known type, and
identifying the heart rhythms in response to the match metric.

The parsed phrases may be further parsed at all prepositions other than “of”. When this is done, and generic words are removed, the program generates the following strings of non-generic verb and noun words.
monitoring heart rhythms
storing digitized electrogram segments
signals depolarizations chamber patient's heart
transforming digitized signals
signal wavelet coefficients
amplitude signal wavelet coefficients
match metric
amplitude signal wavelet coefficients
template wavelet coefficients//
signals heart depolarization
heart rhythms
match metric.

The operation for generating words strings of non-generic words is indicated at 94 in FIG. 5, and generally includes the above steps of removing generic words, and parsing the remaining text at natural punctuation or other syntactic cues, and/or at certain transition words, such as prepositions other than “of.”

The word strings may be used to generate word groups, typically pairs of proximately arranged words. This may be done, for example, by constructing every permutation of two words contained in each string. One suitable approach that limits the total number of pairs generated is a moving window algorithm, applied separately to each word string, and indicated at 96 in the figure. The overall rules governing the algorithm, for a moving “three-word” window, are as follows:
1. consider the first word(s) in a string. If the string contains only one word, no pair is generated;
2. if the string contains only two words, a single two-wordpair is formed;
3. If the string contains only three words, form the three permutations of wordpairs, i.e., first and second word, first and third word, and second and third word;
4. if the string contains more than three words, treat the first three words as a three-word string to generate three two-words pairs; then move the window to the right by one word, and treat the three words now in the window (words 2-4 in the string) as the next three-word string, generating two additional wordpairs (the wordpair formed by the second and third words in preceding group will be the same as the first two words in the present group) string;
5. continue to move the window along the string, one word at a time, until the end of the word string is reached.

For example, when this algorithm is applied to the word string: store digitize electrogram segment, it generates the wordpairs: store-digitize, store-electrogram, digitize-electrogram, digitize-segment, electrogram-segment, where the verb-root words are expressed in their singular, present-tense form and all nouns are in the singular. The non-generic word

The word pairs are stored in a list 52 which, like list 50, will accumulate various types of identifier information in the course of system operation, as will be described below.

Where the text-processing module is used to generate a text database of processed texts, as described below with reference to FIG. 6, the module generates, for each text a record that includes non-generic words and, optionally, word groups derived from the text, the text identifier, and associated library and classification identifiers, and WPIDs.

E. Generating Text and Word-Records Databases

The database in the system of the invention contains text and identifier information used for one or more of (i) determining selectivity values of text terms, (ii) identifying texts with highest target-text match scores, and (iii) determining target-text classification. Typically, the database is also used in identifying target-text word groups present in the database texts.

The texts in the database that are used for steps (ii) and (iii), that is, the texts against which the target text is compared, are called “sample texts.” The texts that are used in determining selectivity values of target terms are referred to as “library texts,” since the selectivity values are calculated using texts from two or more different libraries. In the usual case, the sample texts are the same as the library texts. Although less desirable, it is nonetheless possible in practicing the invention to calculate selectivity values from a collection of library texts, and apply these values to corresponding terms present in the sample texts, for purposes of identifying highest-matching texts and classifications. Similarly, IDFs may be calculated from library texts, for use in searching sample texts.

The texts used in constructing the database typically include, at a minimum, a natural-language text that describes or summarizes the subject matter of the text, a text identifier, a library identifier (where the database is used in determining term selectivity values), and, optionally, a classification identifier that identifies a pre-assigned classification of that subject matter. Below are considered some types of libraries of texts suitable for databases in the invention.

For example, the libraries used in the construction of the database employed in one embodiment of the invention are made up of texts from a US patent bibliographic databases containing information about selected-filed US patents, including an abstract patent, issued between 1976 and the present. This patent-abstract database can be viewed as a collection of libraries, each of which contains text from a particular, field. In one exemplary embodiment, the patent database was used to assemble six different-field libraries containing abstracts from the following U.S. patent classes (identified by CID);
I. Chemistry, classes 8, 23, 34, 55, 95, 96,122, 156, 159, 196, 201, 202, 203,204,205,208, 210, 261, 376, 419,422,423,429, 430, 502, 516;
II. Surgery, classes, 128, 351, 378,433, 600, 601, 602, 604, 606, 623;
III. Non-surgery life science, classes 47, 424, 435, 436, 504, 514, 800, 930;
IV. Electricity classes, 60, 136, 174, 191, 200, 218, 307, 313, 314, 315, 318, 320, 322, 323, 324, 335, 337, 338, 361, 363, 388, 392, 439;
V. Electronics/communication, classes 178, 257, 310, 326, 327, 329, 330, 331, 322, 333, 334, 336, 340, 341, 342, 343, 348, 367, 370, 375, 377, 379, 380, 381, 385, 386,438, 455, and
VI. Computers/software, classes. 345, 360, 365, 369, 382, 700, 701, 702, 703, 704, 705, 706, 707, 708, 709, 710, 711, 712, 713, 714, 716, 717, 725.

The basic program operations used in generating a text database of processed texts is illustrated in FIG. 6. The program processes some large number L of texts, e.g., 5,000 to 500-000 texts from each of N libraries. In the flow diagram, “T” represents a text number, beginning with the first text in the first library and ending with the Lth processed text in the Nth library. The text number T is initialized at 1 (box 89), the library number I at 1 (box 90), and text T is then retrieved from the collection of library texts 32 (box 91). That text is then processed at 34, as above, to yield a list of non-generic words and wordpairs. To this list is added the text identifier and associated library and classification identifiers. This processing is repeated for all texts in library 1, through the logic of 95 and 97, to generate a complete text file for library 1. All of the texts in each successive library are then processed similarly, though the logic of 99, 101, to generate N text files in the database.

Although not shown here, the program operations for generating a text database may additionally include steps for calculating selectivity values for all words, and optionally wordpairs in the database files, where one or more selectivity values are assigned to each word, and optionally wordpair in the processed database texts.

FIG. 6 is a flow diagram of program operation for generating a text database 118 using texts 104 in N defined-field libraries. The program is initialized to text T=1, at 98, and I (library)=1 at 100, then selects text T in library I at 102. This text is processed at 106, as described above with reference to FIG. 5, to produce a list of words, and optionally word pairs. The processed text and identifiers are then added to the database file, as at 108. As noted above, the identifiers for each text include the TID, CID, LID, and for each text word, the WPIDs. This process is repeated for each text T in library l, through the logic of 110, 112, and then for each text T in each additional library l, through the logic of 114, 116, to produce the database 104.

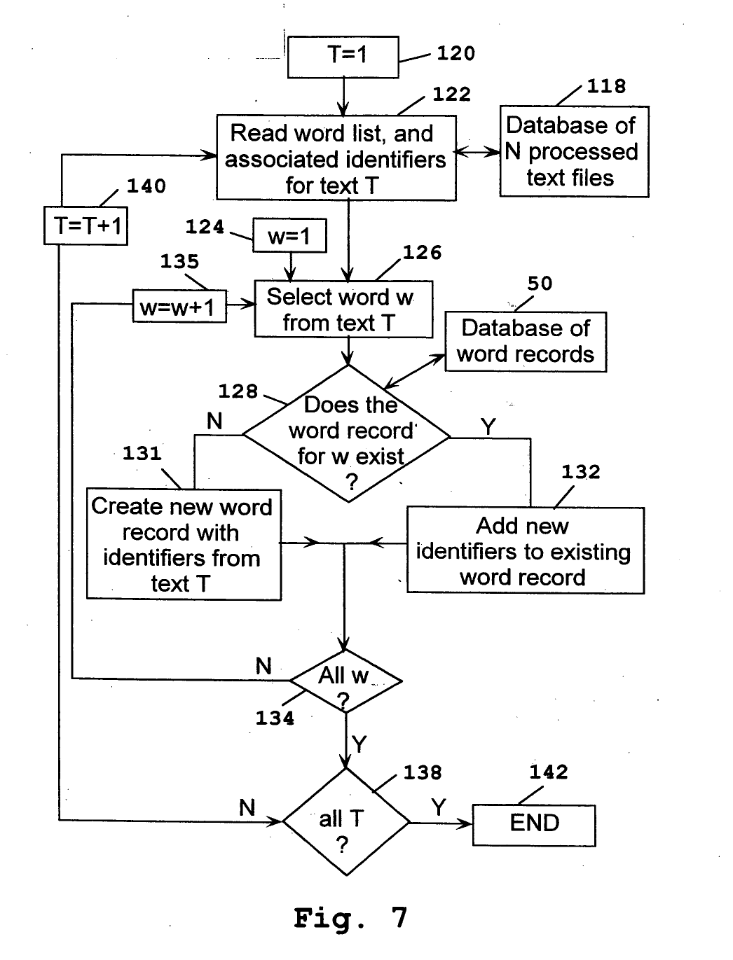

FIG. 7 is a flow diagram of program operations for constructing a word-records database 50 from text database 118. The program initialize text T at 1, (box 120), then reads (box 122) the word list and associated identifiers for text T from database 118. The text word list is initialized word w=1 at 124, and the program selects this word w at 126. During the operation of the program, a database of word records 50 begin to fill with word records, as each new text is processed. This is done, for each selected word w in text T, of accessing the word records database, and asking: is the word already in the database, as at 128. If it is, the word record identifiers for word w in text T are added to the existing word record, as at 132. If not, the program creates a new word record with identifiers from text T at 131. This process is repeated until all words in text T have been processed, according to the logic of 134,135, then repeated for each text, through the logic of 138, 140.

When all texts in all N libraries have been so processed, the database contains a separate word record for each non-generic word found in at least one of the texts, and for each word, a list of TIDs, CIDs, and LIDs identifying the text(s) and associated classes and libraries containing that word, and for each TID, associated WPIDs identifying the word position(s) of that word in a given text.

FIG. 8 shows at pair of word records, identified as “word-x” and “word-y,“in a word record 50 constructed in accordance with the invention. Associated with each word are one or more TIDs, and for each TID, the associated LID, CID, and WPIDs. As shown the word record for word x includes a total of n TIDs. A word record in the database may further include other information, such as SVs and IDFs, although as will be appreciated below, these values are readily calculated from the TID and LID identifiers in each record

F. Extracting Descriptive Terms

The present invention is intended to provide a separate selectivity value for each of the two or more different text libraries that are utilized, that is, text libraries representing texts from two or more different fields or with different classifications. The selectivity value that is used in constructing a search vector may be the selectivity value representing one of the two or more preselected libraries of text, that is, libraries representing one or more preselected fields. More typically, however, the selectivity value that is utilized for a given word or wordpair is the highest selectivity value determined for all of the libraries. It will be recalled that the selectivity value of a term indicates its relative importance in texts in one field, with respect to one or more other fields, that is, the term is descriptive in at least one field. By taking the highest selectivity value for any term, the program is in essence selecting a term as “descriptive” of text subject matter if is descriptive in any of the different text libraries (fields) used to generate the selectivity values. It is useful to select the highest calculated selectivity value for a term (or a numerical average of the highest values) in order not to bias the program search results toward any of the several libraries of texts that are being searched. However, once an initial classification has been performed, it may be of value to refine the classification procedure using the selectivity values only for that library containing texts with the initial classification.

Selectivity values may be calculated from a text database of word-records database, as described, for example, in U.S. patent applications Ser. No. 10/612,739, filed Jul. 1, 2003 and Ser. No. 10/374,877, filed Feb. 25, 2003; both of which are incorporated herein by reference. This section will describe only the operation involving a word-records database, since this approach does not require serial processing of all texts in the database, and thus operates more efficiently. The operations involved in calculating word selectivity values are somewhat different from those used in calculating wordpair selectivity values, and these will be described separately with respect to FIG. 9 and FIGS. 10A and 10B, respectively.

Looking first at FIG. 9, the program is initialized at 156 to the first target text word w, and this word is retrieved at 158 from the list 155 of target-text words. The program retrieves all TIDs and LIDs (and optionally, ClDs) for this word in database 50. To calculate the selectivity value for each of the N libraries, the program initializes to l=1 at 162, and counts all TIDs whose LID corresponds to l=1 and all TIDs whose LIDs correspond to all other libraries. From these numbers, and knowing the total number of texts in each libraries, the occurrence of word w in libraries l and l, respectively (O_{w} and O_{w}) is determined, and the selectivity value calculated as Sₗ=O_{w}/O_{w} as indicated at 164. This calculation is repeated for each library, through the logic of 166, 168, until all l selectivity values are calculated. These values are then attached to the associated word in word list 50, as indicated at 172. The highest of these values, Sₘₐₓ, is then tested against a threshold value, as at 170. If the Sₘₐₓ is greater than a selected threshold value x, the program marks the word in list 50 as descriptive, as at 175. This process is repeated for all words in list 50, through the logic of 173,174, until all of the words have been processed.

The program operations for calculating wordpair selectivity values are shown in FIGS. 10A and 10B. As seen in FIG. 10A, the wordpairs are initialized to 1 (box 176) and the first wordpair is selected from a file 175 of word pairs, as at 177. The program accesses word-records database 50 to retrieve TIDs containing each word in the wordpair, and for each TID, associated WPIDs and LIDs. The TIDs associated with each word in a word pair are then compared at 179 to identify all TIDs containing both words. For each of these “common-word” texts T, the WPIDs for that text are compared at 181 to determine the word distance between the words in the word pair in that text. Thus, for example, if the two words in a wordpair in text T have WPIDs “2-4” and “2-6” (identifying word positions corresponding to distilled sentence 2, words 4 and 6), the text would be identified as one having that wordpair. Conversely, if no pair of WPIDs in a text T corresponded to adjacent words, the text would be ignored.

If a wordpair is present in a given text (box 182), the TIDs and LID for that word pair are added to the associated wordpair in list 175, as at 184. This process is repeated, through the logic of 186, 188, until all texts T containing both words of a given wordpair are interrogated for the presence of the wordpair. For each wordpair, the process is repeated, through the logic of 190, 192, until all non-generic target-text wordpairs have been considered. At this point, list 175 contains, for that wordpairs in the list, all TIDs associated with each wordpair, and the associated LIDs.

The program operation to determine the selectivity value of each wordpair is similar to that used in calculating word selectivity values. With reference to FIG. 10B, the wordpair value “wp” is initialized at 1 (box 194), and the first wp, with its recorded TIDs and LIDs, is retrieved from list 175 (box 196). To calculate the selectivity value for each of the N libraries, the program initializes to library l=1 at 198, and counts all TIDs whose LID corresponds to l=1 and all TIDs whose LIDs correspond to all other libraries. From these numbers, and knowing the total number of texts in each libraries, the occurrence of wordpair wp in libraries l and l, respectively (O_{wp} and O_{wp}) is determined, and the selectivity value Sₗ calculated as O_{wp}/O_{wp} as indicated at 202. This calculation is repeated for each library, through the logic of 203, 204, until selectivity values for all l libraries are calculated. These values are then added to the associated word pair in list 175.

The program now examines the highest selectivity values Sₘₐₓ to determine whether if this value is above a given threshold selectivity value, as at 208. If negative, the program proceeds to the next word, through the logic of 213, 214. If positive, the program marks the word pair as a descriptive word pair, at 216. This process is repeated for each target-text wordpair, through the logic of 213, 214. When all terms have been processed, the program contains a file 175 of each target-text wordpair, and for each wordpair, associated SVs, text identifiers for each text containing that wordpair, and associated CIDs for the texts.

G. Generating a Search Vector

This section considers the operation of the system in generating a vector representation of the target text, in accordance with the invention. As will be seen the vector is used for various text manipulation and comparison operations, in particular, finding primary and secondary texts in a text database that have high term overlap with the target text.

The vector is composed of a plurality non-generic words and, optionally, proximately arranged word groups in the document. Each term has an assigned coefficient that includes a function of the selectivity value of that term. Preferably the coefficient assigned to each word in the vector is also related to the inverse document frequency of that word in one or more of the libraries of texts. A preferred coefficient for word terms is a product of a selectivity value function of the word, e.g., a root function, and an inverse document frequency of the word. A preferred coefficient for wordpair terms is a function of the selectivity value of the word pair, preferably corrected for word IDF values, as will be discussed. The word terms may include all non-generic words, or preferably, only words having a selectivity value above a selected threshold, that is, only descriptive words.

The operation of the system in constructing the search vector is illustrated in FIGS. 11A and 11C. Referring to FIG. 11A the system first calculates at 2O9 a function of the selectivity value for each term in the list of terms 155,175. As indicated above, this list contains the selectivity values, or at least the maximum selectivity value for each word in list 155 and each wordpair in list 175. The function that is applied is preferably a root function, typically a root function between 2 (square root) and 3 (cube root). One exemplary root function is 2.5.

Where the vector word terms include an IDF (inverse document frequency) component, this value is calculated conventionally at 211 using an inverse frequency function, such as the one shown in FIG. 11B. This particular function a zero value for a document frequency (occurrence) of less than 3, decreases linearly between 1 and 0.2 over a document frequency range of 3 to 5,000, then assumes a constant value of 0.2 for document frequencies of greater than 5,000. The document frequency employed in this function is the total number of documents containing a particular word or word pair in all of texts associated with a particular word or word group in lists 155, 175, respectively, that is, the total number of TIDs associated with a given word or word group in the lists. The coefficient for each word term is now calculated from the selectivity value function and IDF. As shown at 213, an exemplary word coefficient is the product of the selectivity value function and the IDF for that word.

IDFs are typically not calculated for word pairs, due to the generally low number of word pair occurrences. However, the word pair coefficients may be adjusted to compensate for the overall effect of IDF values on the word terms. As one exemplary method, the operation at 215 shows the calculation of an adjustment ratio R which is the sum of the word coefficient values, including IDF components, divided by the sum of the word selectivity value functions only. This ratio thus reflects the extent to which the word terms have been reduced by the IDF values. Each of the word pair selectivity value functions are multiplied by this function, producing a similar reduction in the overall weight of the word pair terms, as indicated at 217.

The program now constructs, at 219, a search vector containing n words and m word pairs, having the form:
SV=c₁w₁+ . . . cₙwₙ+c₁wp₁+c₂wp₂+ . . . cₘwpₘ

Also as indicated at 221 in FIG. 11A, the vector may be modified to include synonyms for one or more “base” words (wᵢ) in the vector. These synonyms may be drawn, for example, from a dictionary of verb and verb-root synonyms such as discussed above. Here the vector coefficients are unchanged, but one or more of the base word terms may contain multiple words. When synonyms or employed in the search vector, the word list 155, which includes all of the TIDS for each descriptive word, may be modified as indicated in FIG. 11A. In implementing this operation, the program considers each of the synonym words added, as at 219, and retrieves from database 50, the TIDs corresponding to each synonym, as at 221, forming a search vector with synonyms, as at 220 in FIG. 11C.

As seen in FIG. 11C, the TIDs for each added synonyms are then added to the TIDs in list 50 for the associated base word, as at 225. Final list 155 thus includes (i) each base word in a target text vector, (ii) coefficients for each base word, and (iii) all of the TIDs containing that word and (iv) if a base word includes synonyms, all TIDs for each synonym.

H. Identifying Primary and Secondary Groups of Matched Texts

The text-searching module in the system, illustrated in FIG. 12, operates to find primary and secondary database texts having the greatest term overlap with the search vector terms, where the value of each vector term is weighted by the term coefficient.

An empty ordered list of TIDs, shown at 236 in the figure, stores the accumulating match-score values for each TID associated with the vector terms. The program initializes the vector term at 1, in box 221, and retrieves term dt and all of the TIDs associated with that term from list 155 or 175. As noted in the section above, TIDs associated with word terms may include TlDs associated with both base words and their synonyms. With TID count set at 1 (box 241) the program gets one of the retrieved TIDs, and asks, at 240: Is this TID already present in list 236? If it is not, the TID and the term coefficient is added to list 236, as indicated at 236, creating the first coefficient in the summed coefficients for that TID. Although not shown here, the program also orders the TIDs numerically, to facilitate searching for TIDs in the list. If the TID is already present in the list, as at 244, the coefficient is added to the summed coefficients for that term, as indicated. at 244. This process is repeated, through the logic of 246 and 248, until all of the TIDs for a given term have been considered and added to list 236.

Each term in the search vector is processed in this way, though the logic of 249 and 247, until each of the vector terms has been considered. List 236 now consists of an ordered list of TIDs, each with an accumulated match score representing the sum of coefficients of terms contained in that TID. These TIDs are then ranked at 226, according to a standard ordering algorithm, to yield an output of the top N match score, e.g., the 10 or 20 highest-ranked matched score, identified by TID.

The program may also function to find vector terms that are either unmatched or poorly matched (under-represented) with terms in the top-score matches from the initial (first-tier) search. This function is carried out according to the steps shown in FIG. 13. As seen in this figure, the program takes the texts with the top N scores, typically top 5 or 10 scores, and sets to zero, all of the vector coefficients that occur in at least one of top-ranked texts, as indicated at 252. That is, if a word or word pair occurs in at least one of the top N scores, its coefficient is set to zero, or alternatively, reduced in some systematic manner.

The vector remaining after setting the terms with at least one occurrence to zero becomes a second search vector, containing those words or word pairs that were underrepresented or unrepresented in the original search. The secondary vector is generated at 254, and the search described with respect to FIG. 13 is repeated, at 256, to yield a list of top-ranked texts for the secondary terms. The entire procedure may be repeated, all terms having an above-threshold coefficient, or a preselected number of terms, have been searched.

More generally, the program operates to identify a primary group of texts having highest term match scores with a first subset of the concept-related descriptive terms, where this first subset includes those descriptive target terms present in the top-matched texts. The database is then searched again to identify a secondary group of texts having the highest term match scores with a second subset of the concept-related descriptive terms, where this second subset includes descriptive target terms that are either not present or under-represented in the top-matched texts. The first and second subsets of terms are at least partially complementary with respect to the terms in the list. That is, the first subset of terms includes terms present in the list that are not present in the second subset of terms, and vice versa. In the text-searching operation described above, the first and second subsets of terms are non-overlapping.

In a typical search operation, the program stores a relatively large number of top-ranked primary and secondary texts, e.g., 1,000 of the top-ranked texts in each group, and presents to the user only a relatively small subset from each group, e.g., the top 20 primary texts and the top ten secondary texts. Those lower-ranked texts that are stored, but not presented may be used in subsequent search refinements operations, as will be now be described. In the embodiment described herein, a text is displayed to the user as a patent number and title. By highlighting that patent, the corresponding text, e.g., patent abstract or claim, is displayed in a text-display box, allowing the user to efficiently view the summary or claim from any of the top-ranked primary or secondary references.

I. User Feedback Options for Refining the Search Results

Once the initial search to determine primary and secondary groups of texts with maximum term overlap with the target vector is completed, the program allows the user to assess and refine the quality of the search in a variety of ways. For example, in the user-feedback algorithm shown in FIG. 14A, the top-ranked, e.g., top 20 primary references are presented to the user at 233. The user then selects at 268 those text(s) that are most pertinent to the subject matter being searched, that is, the subject matter of the target text. If the user selects none of the top-ranked texts, the program may take no further action, or may adjust the search vector coefficients and rerun the search. If the user selects all of the texts, the program may present additional lower-ranked texts to the user, to provide a basis for discriminating between pertinent and less-pertinent references.

Assuming one or more, but not all of the presented texts are selected, the program identifies those terms that are unique to the selected texts (STT), and those that are unique to the unselected texts at 270 (UTT). The STT coefficients are incremented and/or the UTT coefficients are decremented by some selected factor, e.g., 10%, and the match scores for the texts are recalculated based on the adjusted coefficients, as indicated at 274. The program now compares the lowest-value recalculated match score among the selected texts (SMS) with the highest-value recalculated match score among the unselected texts (UMS), shown at 276. This process is repeated, as shown, until the SMS is some factor, e.g., twice, the UMS. When this condition is reached, a new search vector with the adjusted score is constructed, as at 278, and the search is text search is repeated, as shown. Rather than search the entire database with the new search vector, the search may be confined to a selected number, e.g., 1,000, of the top matched texts which are stored from the first search, permitting a faster refined search.

Another user-feedback feature allows the user to “adjust” the coefficients of particular terms, e.g., words, in the search vector, and/or to transfer a given term from a primary to a secondary search or vice versa. As will be seen below, the user interface for the search presents to the user, all of the word terms in the search vector, along with an indicator to show whether the word was found in the primary texts (P) or included in the secondary search vector (S). For each word, the user can select from a menu that includes (i) “default,” which leaves the term coefficient unchanged, (ii) “emphasize,” which multiplies the term coefficient by 5, (iii) “require,” which modifies the term coefficient by 100, and (iv) “ignore,” which multiples that term coefficient by 0. The user may also elect to “move” a word from “P” to “S” or vive versa, for example, to ensure that a term forms part of the search for the secondary reference. The user feedback to adjust vector coefficients and search category (P or S) is shown at 284 in FIG. 14B.

Based on the user selections, the program adjusts the term coefficients, as above, and places any selected terms specifically in the primary or secondary search vectors. This operation is indicated at 286. The program now re-executes the search, typically searching the entire database anew, to generate a new group of top-ranked primary and secondary texts, at 288, and outputs the results at 290. Alternatively, the user may select a “secondary search” choice, which instructs the program to confine the refined search to the modified secondary search vector. Accordingly, the user can refine the primary search in one way, e.g., by user selection of most pertinent texts, and refine the secondary search in another way, e.g., by modifying the coefficients in the secondary-search vector.

Another refinement capability, illustrated in FIG. 14C, allows the user to confine the displayed primary or secondary searches to a particular patent class. This is done, in accordance with the steps shown in FIG. 14B, by the user selecting a particular text in the group of displayed primary or secondary texts. The program then searches the top-ranked texts stored at 257, e.g., top 1,000 primary texts or top 1,000 secondary texts, and finds, at 294, those top-ranked texts that have been assigned the same classification as the selected text. The top-ranked texts having this selected class are then presented to the user at 296. This capability may be useful, for example, where the user identifies one text that is particularly pertinent, and wants to find all other related texts that are in the same patent class as the pertinent text.

The search and refinement operations just described can be repeated until the user is satisfied that the displayed sets of primary and secondary references represent promising “starting-point” and “modification” references, respectively, from which the target invention may be reconstructed.

J. Combininq and Filtering Pairs of Primary and Secondary Texts

The sections above describe text-manipulation operations aimed at (i) identifying or generating a target concept in the form of a target text or target term string, (ii) converting the text or term string into a search vector, (iii) using the search vector to identify primary and secondary groups of references that represent “starting-point” and “modification” aspects of concept building, and optionally, (iv) refining the search results by user input. This section describes the final text-manipulation operations in which the program combines primary and secondary texts to form pairs of texts representing candidate “solutions” to the target input, and various filtering operations for assessing the quality of the text pairs as candidate solutions, so that only the most promising candidates are displayed to the user.

The step of combining texts is carried simply by forming all permutations of the top-ranked M primary texts and top-ranked N secondary texts, e.g., where M an N are both the top-ranked 20 texts in each of the two groups, yielding M×N pairs of texts. These pairs may then be presented to the user 20, for example in order of total match score of the primary and secondary texts contained in each pair. The user is able to successively view the texts corresponding with each of M, N texts. In viewing these references, the user might identify a good primary (starting-point) text, for example, and then view only those N pairs containing that primary text.

The filtering operations in the system are designed to assist the user in evaluating the quality of pairs as potential “solutions,” by presenting to the user, those pairs that have been identified as most promising based on one, or typically two or more, of the following evaluation criteria:
(i) Term overlap. This filter quantifies the extent to which terms in the primary text overlap with those of the secondary text in any given pair. A high overlap score indicates that the two texts of a pair share a number of descriptive target terms in common, and are thus likely to be concerned with the same field of invention, or involve common elements or operation.
(ii) Term coverage. Alternatively, or in addition, the system may filter texts pairs based on the extent to which the target-descriptive terms in both texts in a pair cover or span all of the target-descriptive terms. The score that is accorded to each pair is preferably weighted by the target-term coefficients, so that the relative importance of terms is preserved. A high coverage score indicates that collectively, the first and second text in a pair are likely to provide most or all of the important elements of the target.
(iii) Attribute score. Often the user will be able to identify certain attributes that target invention should have, such as “energy efficient,” “capable of being fabricated on a microscale,” “amenable to massive parallel synthesis,” “easily detectable,” or “smooth-surfaced.” When this filter is selected, the program first generates a group of terms that are “attribute-specific” for the indicated attribute, meaning terms that are found with some above-average frequency in texts concerned with the indicated attribute. The program then looks for the presence of one or more of these attribute specific terms in one or both texts in a pair. A high attribute score indicates that at least one of the two references in a pair may have some connection with the attribute desired in the target invention.
(iv) Feature score. Features and attributes are both concept “descriptors” that are characterized by “descriptor-specific” terms, that is, terms that occur with above average frequency in texts containing that descriptor (attribute or feature) term(s). A feature, rather than an attribute, is selected if the user wishes to identify pairs of texts in which the feature term itself is present in one of the two texts in a pair, and a feature-specific term in the other text of the pair. A high feature score indicates that the two texts may be linked by a common, specified feature.
(v) Citation score. One measure of the quality of a text, as a potential starting point or modification text, is the text's citation score, referring to the number of times that text has been cited in subsequent texts, e.g., patents. This filter screens pairs of texts based on a total citation score for both texts of a pair, and therefore displays to the users those pairs of texts having highest overlap citation quality.

The algorithm for the overlap rule filter is shown in FIG. 15. After the user selects the overlap rule at 300, the system operates to select one of the M×N pairs, e.g., 200 pairs of primary and secondary texts from the file 304 of stored text pairs, initially the pair, M, N=1, as at 301. The first target term tᵢ is then selected at 306, and both the primary (M) and secondary (N) texts are interrogated to determine whether tᵢ is present in both texts, as shown at 310. If the term is not present in both texts, the program proceeds to the next term, through the logic of 314 and 316. If the term is present in both texts, the vector coefficient for that term is added to the score for pair M,N, at 312, before proceeding to the next term. The process is repeated until all of the terms in pair M,N, e.g., 1,1, have been considered and scored.

The system then proceeds to the next pair, e.g., 1,2, through the logic of 318, 320, producing a second overlap score at 312, and this process is repeated until all M×N pairs have been processed. The pair scores from 312 are now ranked, at 322, and the top-ranked pairs, e.g., 1-3, 4-6, 1-6, etc., are displayed to the user at 324 for viewing. As seen in the user interface shown in FIG. 21, the user can highlight any indicated pair, e.g., 4-6, and the corresponding primary and secondary texts will be displayed in the associated text boxes.

If the user selects the coverage rule, the program will operate according to the algorithm in FIG. 16 to find pairs of text with maximum target-term overlap. User selection is at 326. The program initializes M, N to 1, retrieves this text pair from file 304, and determines the sum of target-term coefficients for all target terms in either M or N, at 332. The coverage value is expressed as a ratio of the calculated M,N, pair value to the total value of all target-term coefficients, as indicated at 334. This ratio is stored in a file 336. The system then proceeds to the next pair, through the logic of 338, 340, until all of the M×N pairs have been considered. The pair scores from 336 are now ranked, at 342, and the top-ranked pairs are displayed to the user at 344 for viewing. As noted above, the user can highlight any indicated pair, and the corresponding primary and secondary texts will be displayed in the associated text boxes in the output interface.

The operation of the system in filtering text pairs based on one or more specified attributes is illustrated in FIGS. 17A-17D, where the flow diagram in FIG. 17A illustrates steps in the construction of an attribute library. When the user selects an “attribute” filter, the program creates an empty ordered list file of TIDs at 345 and the interface displays an input box 346 in FIG. 17A at which one or more terms, e.g., word and word pairs, that describe or characterize a desired attribute are entered by the user. For example, if the attribute selected is “easily detected,” the user might enter the attribute synonyms of “easily or readily” in combination with “detect or measure, or assay, or view or visualize.” Each of these input terms is an attribute term tₐ.

With tₐ initialized to 1 (box 350), the program selects the first term, and finds all TIDS with that term from words-records database 50, as described above for word terms (FIG. 9) and word-pair terms (FIGS. 10A and 10B). For each TID identified with a particular term, the program asks whether that TID is already present in the file 345, at 356. If no, that TID is added to file 345, at 358. This process is repeated for all TIDs associated with the selected ta, then repeated successively for each ta, through the logic of 360, 362, until all of the attributes have been so processed. At the end of this operation (box 364), file 345 contains a list of all TIDs that contain one or more of the attribute terms. This file thus forms an “attribute library” of all texts containing one or more of the attribute terms.

Although not shown here, the program also generates a “non-attribute” library of texts, that is, a library of texts that do not contain attribute terms, or contain them only with a low, random probability. The non-attribute library may be generated, for example, by randomly selecting texts from the entire database, without regard to content or terms. Typically, the size of (number of texts in) the non-attribute library is at least as large as the attribute library and preferably 2-10 times larger, e.g., 5 times larger, to enhance the statistical measure of attribute-specific terms, as will be appreciated from below.

The attribute file is then used, in the algorithm shown in FIG. 17B, to construct a dictionary of attribute terms, that is, terms that are associated with texts in the attribute library. As shown in the figure, the program creates an empty ordered list of attribute terms at 347, initializes the attribute texts T to 1, then selects a text T from attribute library 345. The terms in text T are extracted from processed text T from a text database 118, whose construction is described with reference to FIG. 6. Each term, i.e., word and wordpair extracted from text T represents a non-generic term in the text, and is indicated as term k in the figure. With k initialized to 1 (box 370), the program selects a term k from processed text T, at 376 and asks, at 377: Is term k in the dictionary of attribute terms, that is, in the list of attribute terms 347. If it is not, it is added to the list at 379. If it is, a counter for that term in the list is incremented, at 382 to count the number of texts in the attribute library that contain that term. This process is repeated from all terms k in text T, through the logic of 384, 386. It is then repeated, through the logic of 388, 389, for all texts T in the attribute library. At the end of the operation, the terms in list 347 may be alphabetized, creating a dictionary of attribute terms, where each term in the dictionary has associated with it, the number of texts in the attribute library in which that term appears.

As indicated at the bottom of FIG. 17B, a similar process is repeated for the texts in the non-attribute library, as at 390, generating a library 392 of “non-attribute” terms and the corresponding text occurrence of each term among the texts of the non-attribute library. Dictionary 392 will, of course, contain all or most of the terms in the attribute dictionary, but at a frequency that is not specific for any particular attribute, or is specific for a different attribute than at issue.

The flow diagram shown in FIG. 17C operates to identify those terms in the attribute dictionary that are specific for the given attribute. That is, attribute-specific terms are those terms, e.g., words and word pairs that are found with some above-average frequency in texts concerned with that attribute. Functionally, the program operates to calculate the text occurrence of each attribute term in the attribute dictionary, relative to the text occurrence of the same term in the non-attribute, then select those terms that have the highest text-occurrence ratio, or specificity for that attribute. Typically, some defined number of top-ranked terms, e.g., top 100 words and top 100 word groups, are selected as the final attribute-specific terms.

With reference to FIG. 17C, the program initializes the dictionary terms t to 1 (box 394), and selects the first term t in the attribute dictionary, at 396. To determine the occurrence ration, the program finds the occurrence of this term Oₜ from the attribute library (AL) at 398, and the occurrence of the same term Oₜ from the non-attribute library, at 402, and calculates the occurrence ratio Oₜ/Oₜ at 406. The ratio is referred to as the attribute selectivity value (SVₜ). The first N (e.g., 100) word and first N (e.g., 100) word pair ratios are placed in a file 410, and each new term thereafter is placed in this file only if its selectivity value is greater than one of the associated words or words pairs already in the file, in which case the lowest-valued word or word pair is removed from the file, through the logic of 408, as the program cycles through each term t, through the logic of 412, 414. The process is complete (box 416) when all terms have been considered, generating a list 410 of top attribute-specific words and word groups. The file of attribute specific terms also contains the SVₜ associated with each term.

The application of the attribute filter to pairs of combined texts is shown in FIG. 17D. The user selects one or more attributes at 418. This may entail selecting a preexisting attribute with its existing file of attribute specific terms, or specifying a new attribute by one or more attribute-related terms, as above. The program initializes the combined texts at M,N=1, at 420, and selects the combined pair M,N, at 422. With p attribute-specific terms initialized to 1, the program selects a term p at 424 from the file 410, and asks at 428: is p in the M,N, pair, that is, is term p contained in either text. If not, the program proceeds to the next term p through the logic of 432 and 436. If the term is in one or both of M,N texts, the program adds the SVt score for p to a file 430 before proceeding to the next term. When all terms p have been considered, file 430 contain the total SVt score for all terms p in text pair M,N.

The operation is repeated for each M,N text pair, through the logic of 434, 436, until all M,N, pairs of texts have been considered. The attribute-specificity score for all M,N, pairs stored in file 430 are now ranked at 438, and the top pairs are displayed to the user at 440.

The operation of the program for filtering combined texts on the basis of one or more selected features, although not shown here, is carried out in a similar fashion. Briefly, for any desired feature, the user will input one or more terms that represent or define that feature. The program will then construct a feature library and from this, construct a file of feature-specific terms, based on the occurrence rate of feature-related terms in the feature library relative to the occurrence of the same terms in a non-feature library. To score paired texts, based on a selected feature, the program looks for pairs of texts that contain the feature itself in one text, and a feature-specific term in the other text, or pairs of texts which each contain a feature-specific term.

FIG. 18 illustrates the operation of the system in filtering pairs of texts on the basis of “quality” of texts, as judged by the number of times that text, e.g., patent has been cited in later-published texts, normalized for time, i.e., the period of time the text has been available for citation. To activate this filter, the user selects the citation rule or filter at 442. The program initializes the paired texts M,N to 1, and finds the total citation score for the two references. This is done at 448 by looking up the citation score for each text in the pair, from a file of citation records 450, and adding the two scores. The citation records are prepared by systematically recording each TID in a text database, scoring the number of times that TID appears as a cited reference in later-issued texts, and dividing the citation score by the age, in months, or the text, to normalize for time. The citation score for that text M,N is stored at 452, and the process is repeated, through the logic of 454 and 456, until all M,N pairs have been assigned a citation score. These scores are then ranked at 458, and the top M,N pairs, e.g., top 10 pairs are displayed to the user.

It will be appreciated that two or more of the filters may be employed in succession to filter pairs of texts on different levels. For example, one might rank pairs of texts based on term overlap, then further rank the pairs of texts with a selected attribute filter, and finally on the basis of citation score. Where two or more filters are employed, the program may rank pairs of text based on an accumulated score from each filter, or alternatively, successively discard low-scoring pairs of texts with each filter, so that the subsequent filter is only considering the best pairs from a previous filter operation.

K. User Interfaces

This section describes three user interfaces that are employed in the system of the invention, to provide the reader with a better understanding of the type of user inputs and machine outputs in the system.

FIG. 19 shows a graphical interface for the search phase of the system. The target text, that is, a description of the concept one wishes to generate and some of its properties or features, are entered in the text box at the upper left. By clicking on “Add Target,” the user enters this target in the system, identified as target 31 in the Target List. The search is initiated by clicking on “Primary Search.” Here the system processes the target texts, identifies the descriptive words and word pairs in the text, constructs a search vector composed of these terms, and searches a large database, in this example, a database of about 1 million U.S. patent abstracts in various technical fields, 1976-present.

The program operates, as described above, to find the top-matched primary and secondary references, and these are displayed, by number and title, in the two middle text boxes in the interface. By highlighting one of these text displays, the text record, including patent number, patent classification, full title and full abstract are given in the corresponding text boxes at the bottom of the interface.

To refine the primary texts by class, the user would highlight a displayed patent having that class, and click on Refine by class. The program would then output, as the top primary hits, only those top ranked texts that also have the selected class.

To refine either the primary or secondary searches by word emphasis, the user would scroll down the words in the Target Word List until a desired word is found. The user then has the option, by clicking on the default box, to modify the word to emphasize, require, or ignore that word, and in addition, can specify at the left whether the word should be included in the primary search vector (P) or the secondary search vector (S). Once these modifications are made, the user selects either Primary search which then repeats the entire search with the modified word values, or Secondary search, in which case the program executes a new secondary search only, employing the modified search values.

FIG. 20 shows the user interface for filtering and selecting paired texts. The primary and secondary texts from the previous search are displayed at the center two text boxes in the interface. By selecting one or more of the filters (the features filter is not shown here), the program will execute the selected filter steps and display the top text pairs in the Top Pair Hits box at the lower middle portion of the screen. This will display pairs of primary and secondary references whose details are shown in the two bottom text boxes. Thus, for example, by highlighting the pair “17-6” in the box, the details of the 17^{th} primary text and the 6^{th} secondary text are displayed in the two lower text boxes as shown.

When the attribute filter is selected, the user has the option of creating a new attribute or selecting an existing attribute shown in the Available attribute box. If the user elects to create a new attribute, the attribute interface shown in FIG. 21 is displayed. To create a new attribute, the user assigns an attribute name (Descriptor name) and enters the attribute terms, e.g., attribute definitions and synonyms in the left middle text box. The Create library command then initiates the program of (i) generating an attribute library, (ii) finding all attribute-specific terms, and (iii) presenting these terms in the Dictionary box at the right in the interface. As shown, the interface allows the user to delete any of these terms. By clicking on OK, the user signals that the attribute list is now ready for use in the attribute filter.

From the foregoing, it will be seen how various objects and features of the invention have been met. As noted in Section B, generating new concepts or inventions can be viewed as a series of selection steps, each requiring user information to make a suitable or optimal choice at each stage, and illustrated by the bar graphs shown in FIGS. 1 B and 2B for a human-generated invention. Since the present invention employs various text mining operations to assist in finding primary (staring point) and secondary (modification) references, and in identifying optimal combinations of texts, the system can significantly reduce the information-input needed by an inventor to generate a new concept. The information difference, as will now be appreciated, is supplied by various text-mining operations carried out by the system designed to (i) identify descriptive word and word-group terms in natural-language texts, (ii) locate pertinent primary and secondary texts, and (iii) select optimal pairs of texts based on various types of statistically significant (but generally hidden) correlations between the texts.

While the invention has been described with respect to particular embodiments and applications, it will be appreciated that various changes and modification may be made without departing from the spirit of the invention.

1. A computer-assisted method for combining texts to form novel combinations of texts related to a desired target concept that is represented in the form of a natural-language text or a list of descriptive terms that include words and, optionally, word groups, said method comprising
(A) if the target concept is represented in the form of a natural-language text, extracting descriptive word and, optionally, word-group terms from the text, to form a list of descriptive terms,
(B) searching a database of target-related texts, to identify a primary group of texts having highest term match scores with a first subset of said terms,
(C) searching a database of target-related texts, to identify a secondary group of texts having the highest term match scores with a second subset of said terms, where said first and second subsets are at least partially complementary with respect to the terms in said list,
(D) generating pairs of texts containing a text from the primary group of texts and a different text from the secondary group of texts, and
(E) selecting for presentation to the user, those pairs of texts that have highest overlap scores as determined from one or more of:
(E1) overlap between descriptive terms in one text in the pair with descriptive terms in the other text in the pair;
(E2) overlap between descriptive terms present in both texts in the pair and said list of descriptive terms;
(E3) for one or more terms in one of the pairs of texts identified as feature terms, the presence in the other pair of texts of one or more feature-specific terms defined as having a substantially higher rate of occurrence in a feature library composed in texts containing that feature term,
(E4) for one or more attributes associated with the target invention, the presence in at least one text in the pair of attribute-specific terms defined as having a substantially higher rate of occurrence in an attribute library composed in texts containing a word-and/or word-group term that is descriptive of that attribute, and
(E5) a citation score related to the extent to which one or both texts in the pair are cited by later texts.

2. The method of claim 1, wherein descriptive terms in the target concept are identified as non-generic terms that have a selectivity value, calculated as the frequency of occurrence of that term in a library of texts in one field, relative to the frequency of occurrence of the same term in one or more other libraries of texts in one or more other fields, respectively, above a given threshold value.

3. The method of claim 1, wherein the target concept is represented in the form of a natural-language text, and step (A) includes
(A1) for each of a plurality of terms selected from one of (i) non-generic words in the text, (ii) proximately arranged word groups in the document, and (iii) a combination of (i) and (ii), determining a selectivity value calculated as the frequency of occurrence of that term in a library of texts in one field, relative to the frequency of occurrence of the same term in one or more other libraries of texts in one or more other fields, respectively, and
(A2) selecting as descriptive terms, those terms that have a selectivity value above a selected threshold.

4. The method of claim 1, wherein step (B) includes
(B1) representing the list of terms as a first vector of terms,
(B2) determining for each of a plurality of database texts, a match score related to the number of terms present in or derived from that text that match those in the first vector, and
(B3) selecting one or more of the texts having the highest primary-vector match scores, where the first subset of terms includes terms present in at least one of the selected, highest match score texts in the first group of texts.

5. The method of claim 4, wherein the coefficients assigned to each term in the first vector is related to the selectivity value determined for that term, calculated as the frequency of occurrence of that term in a library of texts in one field, relative to the frequency of occurrence of the same term in one or more other libraries of texts in one or more other fields, respectively, above a given threshold value.

6. The method of claim 3, which further includes adjusting the effective coefficients assigned to selected terms in said first vector, based on user input related to one or more user-selected terms, and the system carries out or repeats step (B) with the adjusted-value vector, thereby to increase the probability that the selected term(s) in said list will be present in said first group of texts.

7. The method of claim 3, wherein step (C) includes
(C1) forming a second vector of terms that are unrepresented or underrepresented in the highest ranked primary texts,
(C2) determining for each of a plurality of sample texts, a match score related to the number of terms present in or derived from that text that match those in the second vector, and
(C3) selecting one or more of the secondary texts having the highest secondary-vector match scores, where the second subset of terms includes terms present in at least one of the selected, highest match score texts in the second group of texts.

8. The method of claim 7, wherein the coefficients assigned to each term in the second vector is related to the selectivity value determined for that term, calculated as the frequency of occurrence of that term in a library of texts in one field, relative to the frequency of occurrence of the same term in one or more other libraries of texts in one or more other fields, respectively.

9. The method of claim 7, which further includes adjusting the effective coefficients assigned to selected terms in said second vector, based on user-input related to one or more user-selected terms, and the system carries out or repeats step (C) with the adjusted-value vector, thereby to increase the probability that the selected term(s) in said list will be present in said second group of texts.

10. The method of claim 1, wherein step (E) includes selecting for presentation to the user, those pairs of database texts that have the highest overlap scores as determined from one or both of:
(E1) overlap between descriptive terms in one text in the pair with descriptive terms in the other text in the pair; and
(E2) overlap between descriptive terms present in at least one text in the pair and said list of descriptive terms;

11. The method of claim 1, wherein step (E) includes selecting for presentation to the user, those pairs of database texts that have the highest overlap scores as determined from one or both of:
(E3) for one or more terms in one of the pairs of texts identified as feature terms, the presence in the other pair of texts of one or more feature-specific terms defined as having a substantially higher rate of occurrence in a feature library composed in texts containing that feature term,
(E4) for one or more attributes associated with the target invention, the presence in at least one text in the pair of attribute-specific terms defined as having a substantially higher rate of occurrence in an attribute library composed in texts containing a word-and/or word-group term that is descriptive of that attribute, and

12. The method of claim 11, wherein step (E3) includes
(E3a) user-selection of one or more non-generic terms in said list of terms as feature terms,
(E3b) for each feature term selected in (E3a), determining a feature-term selectivity value related to the occurrence of that term in the texts of the associated feature library relative to the occurrence of the same term in one or more different libraries of texts,
(E3c) using the feature-term selectivity values determined in (E3b) to identify terms that are feature specific for the associated feature.

13. The method of claim 11, wherein step (E4) includes
(E4a) user selection of one or more attribute terms desired in the concept,
(E4b) for each attribute term selected in (E4a), determining an attribute-specific selectivity value related to the occurrence of that attribute term in the texts of the associated attribute library relative to the occurrence of the same term in one or more different libraries of texts,
(E4c) using the attribute-term selectivity values determined in (E4b) to identify terms that are attribute specific for the associated attribute.

14. The method of claim 1, wherein step (E) includes selecting for presentation to the user, those pairs of database texts that have the highest overlap scores as determined from a citation score related to the extent to which one or both texts in the pair are cited by later texts.

15. The method of claim 1, wherein the target concept and the associated database searched is selected from
(1) a novel combination of existing inventions, wherein the database searched in steps (B) and (C) is a database of patent abstracts or claims;
(2) a discovery and one or more potential applications of the discovery, wherein the database searched in steps (B) and (C) is a database of patent abstracts or claims;
(3) a novel combination of storylines, wherein the database searched in steps (B) and (C) is a database of abstracts of stories.

16. An automated system for combining texts to form novel combinations of texts related to a desired target concept that is represented in the form of a natural-language text or a list of descriptive terms that include words and, optionally, word groups, comprising
(1) a computer,
(2) accessible by said computer, a database of texts that include texts related to the selected concept, and
(3) a computer readable code which is operable, under the control of said computer, to perform the steps of claim 1.

17. Computer readable code for use with an electronic computer and a database a of texts that include texts related to a selected concept, for combining texts to form novel combinations of texts related to the selected concept, where the concept is represented in the form of a natural-language text or a list of descriptive terms that include words and, and said code is operable, under the control of said computer, to perform the steps of claim 1.

18. A feature or attribute descriptor dictionary comprising
a list of feature and/or attribute descriptors, and
for each descriptor, a list of word and/or word-group terms that are that are descriptor specific for that descriptor, where a term is descriptor specific for a given descriptor if the term has a substantially higher rate of occurrence in a descriptor library composed in texts containing a word-and/or word-group term that is the same as or descriptive of that descriptor than the same term has in a library of texts unrelated to that descriptor.
